(19) United States
(12) Patent Application Publication
(10) Pub. No.: US 2026/0141318 A1
(43) Pub. Date: May 21, 2026

(54) PROGRAM, INFORMATION PROCESSING METHOD, AND SERVER

(71) Applicant: LY CORPORATION, Tokyo (JP)

(72) Inventors: Hiromu ARIGA, Tokyo (JP); Kei WAKABAYASHI, Tokyo (JP); Kazuki MATSUMOTO, Tokyo (JP); Takayuki YAMAMOTO, Tokyo (JP); Amane MUKAI, Tokyo (JP)

(73) Assignee: LY CORPORATION, Tokyo (JP)

(21) Appl. No.: 19/391,235

(22) Filed: Nov. 17, 2025

(30) Foreign Application Priority Data
Nov. 16, 2024 (JP) 2024-200150

(51) Int. Cl. G06Q 10/02; G06F 16/3329

(52) U.S. Cl. CPC G06Q 10/025; G06F 16/33295

(57) ABSTRACT

A program to be executed by a server that communicates with a terminal to cause the server to generate, by a controller of the server, an itinerary based on information transmitted from the terminal, transmit, by the controller, the generated itinerary to the terminal, determine, by the controller, at least one of a question or at least one response option to the question, based on (i) information regarding the itinerary and (ii) user information about a user of the terminal, transmit, by the controller, the question and the response option to the terminal, and perform, by the controller, processing for reserving a service or a facility included in the itinerary based on a response selected from the at least one response option by the user of the terminal may be provided. Accordingly, an itinerary that reflects a user's preferences may be generated.

### CROSS-REFERENCE TO RELATED APPLICATIONS

This (U.S. non-provisional patent) application claims priority under 35 U.S.C. § 119 to Japanese Patent Application No. 2024-200150, filed on Nov. 16, 2024, the entire contents of which are incorporated herein by reference.

### BACKGROUND

### 1. Technical Field

Some example embodiments of the present disclosure relate to programs, information processing methods, servers, and the like.

### 2. Description of Disclosure

As a technology of creating an itinerary based on a user's preferences, a travel planning system may generate an analysis model for evaluating preferences based on user's preferences, and create a travel plan that matches the user's preferences based on the analysis model.

### SUMMARY

An example embodiments of the present disclosure provides a non-transitory computer readable medium storing a program to be executed by a server that communicates with at least one terminal, the program configured to cause the server to generate, by a controller of the server, an itinerary based on information transmitted from the terminal, transmit, by the controller, the generated itinerary to the terminal, determine, by the controller, at least one of a question or at least one response option to the question, based on (i) information regarding the itinerary and (ii) user information about a user of the terminal, transmit, by the controller, the question and the response option to the terminal, and perform, by the controller, processing for reserving a service or a facility included in the itinerary based on a response selected from the at least one response option by the user of the terminal.

An example embodiments of the present disclosure provides an information processing method to be performed by a server that communicates with a terminal, the method including generating, by a controller of the server, an itinerary based on information transmitted from the terminal, transmitting, by the controller, the generated itinerary to the terminal, determining, by the controller, at least one of a question or at least one response option to the question, based on (i) information regarding the itinerary and (ii) user information about a user of the terminal, transmitting, by the controller, the question and the response option to the terminal, and performing, by the controller, processing for reserving a service or a facility included in the itinerary, based on a response selected from the at least one response option by the user of the terminal.

According to an example embodiments of the present disclosure, a server that communicates with a terminal includes a controller configured to generate an itinerary based on information transmitted from the terminal, transmit the generated itinerary to the terminal, determine at least one of a question or a response option to the question, based on (i) information regarding the itinerary and (ii) user information about a user of the terminal, and perform processing for reserving a service or a facility included in the itinerary, based on a response selected from the response option by the user of the terminal.

### BRIEF DESCRIPTION OF THE DRAWINGS

FIG. 1 shows an example of a system configuration of a communication system according to a first example embodiment.

FIG. 2 shows an example of a function implemented by a controller of a server according to the first example embodiment.

FIG. 3 shows an example of information stored in a storage of the server according to the first example embodiment.

FIG. 4 shows an example of account registration data according to the first example embodiment.

FIG. 5 shows an example of a function implemented by a controller of a terminal according to the first example embodiment.

FIG. 6 shows an example of information stored in a storage of the terminal according to the first example embodiment.

FIGS. 7A, 7B and 7C show examples of screens appearing on a display of the terminal according to the first example embodiment.

FIGS. 8A, 8B and 8C show examples of screens appearing on the display of the terminal according to the first example embodiment.

FIG. 9 is a flowchart showing an example of a processing flow performed by the devices according to the first example embodiment.

FIGS. 10A, 10B and 10C show examples of screens appearing on a display of a terminal according to a second example embodiment.

FIGS. 11A, 11B and 11C show examples of screens appearing on a display of a terminal according to a third example embodiment.

FIG. 12 shows an example of control performed by a server according to a fourth example embodiment.

FIGS. 13A, 13B and 13C show examples of screens appearing on a display of a terminal according to a fifth example embodiment.

### DETAILED DESCRIPTION

Compliance with Legal Requirements

It should be noted that the disclosure provided herein is premised on compliance with legal requirements, such as secrecy of communication, in the country in which the present disclosure is to be implemented.

### Example Embodiments

Note that the phrase “for example” is used in some parts of the present specification for ease of understanding, while it should be noted that not only those parts but the entirety of the following example embodiments is not limited to the content described therein.

As used herein, the term “and/or” includes any and all combinations of one or more of the associated listed items. Expressions such as “one of,” “one or more of,” “any one of,” and “at least one of,” when preceding a list of elements, modify the entire list of elements and do not modify the individual elements of the list. Thus, for example, both “at least one of A, B, or C” and “at least one of A, B, and C” mean either A, B, C or any combination thereof.

The following describes some example embodiments for implementing a program and the like, with reference to the drawings.

The production of a terminal of the present disclosure according to the claims of the present application (a terminal of the present disclosure) may include, for example, a concept that a state in which the functions of the present disclosure according to the claims of the present application are implementable is achieved on the terminal owned (carried) by a user (e.g., a state in which the present disclosure according to the claims of the present application are implementable is achieved) as a result of this terminal receiving (or receiving and storing) a program (e.g., an application program) or the like described herein.

Also, the production of a system of the present disclosure according to the claims of the present application (a system of the present disclosure) may include, for example, a concept that a state in which the functions of the system of the inventive concepts according to the claims of the present application are implementable is achieved (e.g., a state in which the present disclosure according to the claims of the present application are implementable is achieved) as a result of a terminal included in the system of the present application receiving a program (e.g., an application program) or the like described herein that is transmitted from a server included in the system of the present application (or as a result of the received program being stored in the terminal).

As used herein, the term “system” may include a plurality of devices. For example, the plurality of devices may be a combination of devices of the same type, a combination of devices of different types, or a combination of devices of the same type and devices of different types. Note that, for example, the system can also be considered as performing certain processing with the plurality of devices cooperating with each other.

The term “a system related to a client (client device) and a server” may be, for example, considered as at least one of the following cases:
(1) a terminal and a server;
(2) a server; or
(3) a terminal.

In the case (1), the system includes, for example, at least one terminal and at least one server. The system in this example embodiment is a client-server system.

The server is constituted by, for example, the following devices, which may be a single device or a combination of a plurality of devices. For example, the server may have, for example, any one or more of the following: a processor (e.g., a central processing unit (CPU), a graphics processing unit (GPU), an accelerated processing unit (APU), a digital signal processor (DSP; e.g., an application specific integrated circuit (ASIC), a field programmable gate array (FPGA) etc.), a computer device (a processor and a memory), a control device, an arithmetic device, or a processing unit. The server may include two or more of any one of the above devices of the same type (e.g., two CPUs, a homogeneous multi-core processor etc.) or include two or more of any one of the above devices of different types (e.g., a CPU and a DSP, a heterogeneous multi-core processor etc.), or may be a combination of two or more devices (e.g., a processor and a computer device, a processor and an arithmetic device, a heterogeneous configuration of two or more devices, etc.). Note that the processor may be a virtual processor.

When the server constituted by a single device performs a certain type of processing, the single device performs the processing described in some example embodiments. If the server is constituted by a plurality of devices, some of the devices may perform one part of the processing and another device may perform the other part of the processing. For example, if the server includes a processor and an arithmetic device, the processor may perform first processing and the arithmetic device may perform second processing. If the server includes a plurality of devices, the devices may be disposed at physically separated locations.

Functions of the server may be provided, for example, in the form of PaaS, IaaS, or SaaS in cloud computing.

A controller of the system can be at least either a controller of the terminal or a controller of the server. That is, for example, any of the following can be the controller of the system: (1A) only the controller of the terminal; (1B) only the controller of the server; and (1C) both the controller of the terminal and the controller of the server.

Control and processing (hereinafter collectively referred to as “control and the like”) performed by the controller of the system may be: (1A) performed solely by the controller of the terminal; (1B) performed solely by the controller of the server; or (1C) performed by both the controller of the terminal and the controller of the server.

In the case (1C), for example, part of control and the like performed by the controller in the system may be performed by the controller of the terminal, and the remainder of the control and the like may be performed by the controller of the server. In this case, the allocation of the control and the like may be equal or different from the equal allocation.

If the server is constituted by a single apparatus, the term “a communication device of the server” may refer to a communication device included in the single apparatus. If the server includes a plurality of devices, the communication device of the server may include communication devices included in the respective devices.

For example, if the server includes a first device and a second device, the first device has a first communication device, and the second device has a second communication device, the term “a communication device of the server” may refer to a concept that includes the first communication device and the second communication device.

In the case (2), the system may include, for example, a plurality of servers (hereinafter referred to as a “server system”). In this case, the aforementioned configuration can be similarly applied to each of the servers.

Control and the like performed by the server system may be performed by: (2A) only one of the plurality of servers; (2B) only another one of the servers; or (2C) one server and another server out of the plurality of servers.

In the case (2C), for example, part of control and the like performed by the server system may be performed by one server, and the remainder of the control and the like may be performed by another server. In this case, the allocation of the control and the like may be equal or different from the equal allocation.

In the case (3), the system may include, for example, a plurality of terminals.

This system may be, for example, as follows:
a system in which terminals have server functions (distributed system), which can be implemented, for example, by using a blockchain technology; or
a system in which terminals wirelessly communicate with each other, which can be implemented, for example, by performing communication in a P2P (peer-to-peer) method using a short-range wireless communication technology, such as Bluetooth (registered trademark).

Note that the above description is not limited to the controller, but also applies to functional parts such as input/output devices, communication devices, storages, and clocks that can be constituent elements of the system.

In the following example embodiments, for example, a system that includes terminals and a server (e.g., a client-server system) will be illustrated.

Note that the server system in the above case (2) can also be applied as the server.

Instead of the system that includes terminals and a server, for example, the system in the above case (3) can be applied as a system that does not include a server.

An example embodiment in this case can be configured based on the aforementioned blockchain technology or the like. For example, data stored and managed in a server described in the following embodiments is kept (stored) on a blockchain. The terminal generates a transaction to the blockchain, and data kept on the blockchain can be updated upon the transaction being approved on the blockchain.

Note that, even when the term “terminal” is used, this is not limited to the meaning of a terminal as a client device in a client-server system. That is, the term “terminal” may also include a concept of a device that is not included in a client-server system.

In the present specification, the expression “via a communication I/F” is used as appropriate. This expression means that, for example, a device may transmit and receive various types of information and data via the communication I/F (via a communication device) under the control of a controller (a processor, etc.).

Regarding the terms “related to” and “associated with” as used herein, “B related to A” and “B associated with A” may mean, for example, that B has a certain relationship with A. A specific example will be described later.

When a device performs processing targeting two or more objects, such as “transmitting A and B” or “receiving A and B” as used herein, the processing may be performed at the same time for A and B (hereinafter expressed as “synchronously”) or at different times for A and B (hereinafter expressed as “asynchronously”).

For example, when first information and second information are transmitted, this may include both concepts of transmitting the first information and the second information at the same time and transmitting the first information and the second information at different times.

Note that, considering a lag (time lag), “synchronously” may include “substantially synchronously”.

Note that, when processing is performed at different times for A and B, this need only mean that the processing is performed targeting A and B, and the purpose need not necessarily be the same.

For example, when the first information and the second information are transmitted as mentioned above, the first information and the second information need only be transmitted, and this may include a case where the first information and the second information are transmitted for the same purpose, and a case where the first information and the second information are transmitted for different purposes.

In the following example embodiments, a messaging service is illustrated as an example of a service used by users to chat (hereinafter referred to as a “chat service”). An application for realizing the chat service is referred to as a “chat application”. An application for realizing the messaging service is referred to as a “messaging application”.

For example, the chat application enables users to chat in a chat room.

Note that the messaging service (MS; including an instant messaging service (IMS)) can also be considered as one form of a social networking service (social media platform). Thus, the messaging service and the social networking service may be, but need not necessarily be, distinguished from each other. That is, the social networking service may include the messaging service.

In the following example embodiments, an instant messaging service (IMS), in which simple messages are transmitted and received between a plurality of devices (e.g., terminals) via a server, will be illustrated as an example of a messaging service.

An instant messaging application enables users to talk in a talk room, for example.

A chat room (e.g., a talk room) may be a user interface (UI) or a graphical user interface (GUI) that enables each user to view content transmitted and received between terminals of a plurality of users.

A messaging service enables, for example, a user to exchange messages via a talk room by registering any account as a “friend”.

For example, a “friend” may be considered as the relationship between first and second users of the messaging application when the accounts of the first and second users are unidirectionally or bidirectionally associated.

For example, when the account of the first user and the account of the second user are mutually associated, the first and second users may be called “friends”. Also, for example, when the first user has associated their account with the account of the second user, the first and second users may be called “friends” even if the second user has not associated their account with the account of the first user.

Talk rooms may include, for example, a one-on-one user talk room (hereinafter referred to as a “one-on-one talk room”), a talk room for a group including a plurality of users (hereinafter referred to as a “group talk room”), a talk room for talking with an official account (OA) operator (e.g., a business operator partnered with the messaging service provider) (hereinafter referred to as an “OA talk room”).

An account of a business operator that is an account on a messaging application and is not a general user may be referred to as an “official account (OA),” and the user of the official account may be referred to as an “official user.” Note that this may also be referred to as an “official account user” or “official account operator”, for example. Meanwhile, an account of a user that is an account on a messaging application and is not an OA operator is referred to as a “general account”, and a user with a general account is called a “general user”. Note that this may also be referred to as a “general account user”, for example. That is, accounts on a messaging application may include general accounts and official accounts.

An OA operator may be able to, for example, transmit and receive messages to and from other devices via a server, using a terminal similar to a terminal of a user with a general account.

A message (message information) is, for example, information for which a transmission source and a transmission destination used in a messaging service are determined, and may be information constituted by identification information (a message ID) for identifying the message, and message content. The message content may mean the content of a message excluding the message ID, for example. The message content may include one or more content items.

Information set as identification information for identifying a message is referred to as a “message ID”. It can also be considered that the message content included in a message with the same message ID is identified by this message ID. Therefore, it can also be considered that the identification information for identifying a message has substantially the same meaning as the identification information for identifying the message content. Note that, unlike this, individual identification information (message content IDs) may optionally be set for each message content item.

The term “content” may include, for example, text content in the form of text, image content in the form of images (including at least either a still image or a moving image), and sound content in the form of sound (including voice). Note that the term “content” may also include operable content such as a button and an icon to be operated by the user, and link content such as a URI (including a URL etc.).

The term “text” may include, for example, at least one of characters of any country, extended characters, machine-dependent characters, numerals, symbols, graphics, or signs that are represented by character codes. Note that the term “text” need not necessarily include at least one of the aforementioned characters, extended characters, machine-dependent characters, numerals, symbols, graphics, or signs, and may also include any other type of text.

The term “image” may include, for example, at least one of various types of image information such as an icon, a button, a stamp, an emoji, and a banner image.

Note that, unlike the above definitions, it may optionally be defined that “content” is a superordinate concept of a message, or that “content” and “message” have the same meaning.

As an example, when an itinerary such as a travel plan is created using an application or the like, it is desirable to create and provide an itinerary that matches a user's preferences in the shortest possible time. Some example embodiment of the present disclosure relate to technologies capable of providing an itinerary that matches a user's preferences in a relatively short time by presenting questions and response options to the questions to the user and having the user select responses from the response options.

Here, the term “itinerary” may include, for example, an activity plan in the case of traveling or moving. The term “itinerary” may include, for example, chronological and/or spatial designation elements (which may also be referred to as “itinerary elements”), such as any of the elements below. The term “itinerary” may also be rephrased as a “travel plan”.
Departure point and scheduled departure time
Destination and scheduled arrival time
Transportation and time required or desired
Name and address of accommodation facility
Name and address of sightseeing spot
Order of visiting sightseeing spots and length of stay
Eating place and meal content
Budget and payment method

The following describes an example in which, for example, an itinerary is generated based on an interaction with a chatbot account in a messaging service. Note that, without limitation to a messaging service, the itinerary generation may also be implemented in a conversational AI system, such as ChatGPT.

In the following, a question answering system (which may also be referred to as a “question answering model”) may be used as an example of a method of realizing processing. The question answering system may be, for example, a closed-book question answering system implemented by a language model such as HyperCLOVA, GPT-4, or Llama. Also, the question answering model may be, for example, an open-book question answering system implemented by a combination of a language model and an external knowledge retrieval model such as a dense passage retriever (DPR) or a binary passage retriever (BPR). The question answering system may be configured to generate an output sentence (response sentence) in cooperation with any external database.

### First Example Embodiment

In the first example embodiment, for example, a server creates an itinerary and an itinerary video for a user based on the content of messages transmitted to and received from the user.

The content described in the first example embodiment can also be applied in the same manner to any other example embodiments and variations.

In the following example embodiment, for example, a service for realizing itinerary creation assistance is referred to as a “travel plan creation assistance service”. The travel plan creation assistance service may become available based on or as a result of the user interacting with a chatbot in a messaging application, for example.

Note that, for example, any of the following modes can be applied as a mode for realizing the travel plan creation assistance service:
(A1) a mode in which a messaging application has the function of the travel plan creation assistance service as one of its functions;
(A2) a mode in which a travel plan creation assistance application that provides the travel plan creation assistance service has the function of the messaging service as one of its functions;
(B1) a mode of configuring an application (integrated application) that has the functions of the messaging service and the travel plan creation assistance service;
(C1) a mode of configuring a travel plan creation assistance application as an application separate from a messaging application;
(C2) a mode of configuring a messaging application as an application separate from a travel plan creation assistance application; and
(D) a mode of configuring a travel plan creation assistance application as a standalone application.

In the modes (A1), (A2), and (B1), for example, the messaging service provider can be the same as the travel plan creation assistance service provider. In this case, a configuration in which the user uses the same user account across the messaging application and the travel plan creation assistance application is possible. Also, in this case, a configuration in which a user account on the messaging application is automatically associated (linked) with a user account on the travel plan creation assistance application is possible.

In the modes (C1) and (C2), for example, the messaging service provider may be different from the travel plan creation assistance service provider. In the modes (C1) and (C2), it is possible to perform processing for associating (linking) a user account on the messaging application with a user account on the travel plan creation assistance application.

In the following description, for example, the messaging service provider manages and administers a server 10 for providing the messaging service and the travel plan creation assistance service, in accordance with the mode (A1).

In the following description, a user of a terminal 20A that communicates with the server 10 is referred to as a “user A.A”, a user of a terminal 20B as a “user B.B”, a user of a terminal 20C as a “user C.C”, and so on.

### System Configuration

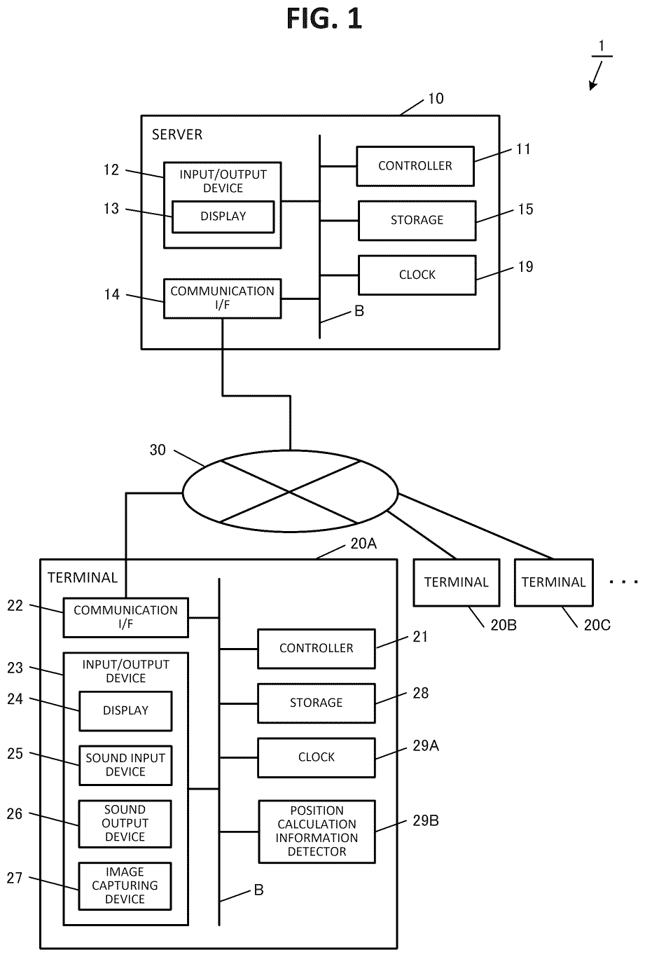

FIG. 1 shows an example of a system configuration of a communication system 1 according to this example embodiment. In the communication system 1, for example, the server 10 and a plurality of terminals 20 (terminals 20A, 20B, 20C, . . . ) are connected to each other via a network 30.

The server 10 functions to provide, for example, a messaging service and a travel plan creation assistance service to the terminals 20 owned by the users, via the network 30.

The server 10 can also be referred to as, for example, a messaging service server, a travel plan creation assistance server, or a social media platform server. In this example embodiment, for example, the user of the server 10 is a company that provides the messaging service and the travel plan creation assistance service (a provider of the messaging service and the travel plan creation assistance service). Note that the number of servers 10 and terminals 20 that are connected to the network 30 is not limited to the above.

In this example embodiment, the “travel plan creation assistance service” is a service provided by the provider (server 10) that is a company or the like providing the travel plan creation assistance service, and may be provided to, for example, the users (the terminals 20 of the users).

Each of the terminals 20 (terminals 20A, 20B, 20C, . . . ) may be any type of information processing terminal that is capable of realizing the functions described in some example embodiments. Examples of the terminals 20 include a smartphone, a mobile phone (a feature phone), a computer (e.g., a desktop, a laptop, or a tablet), a media computer platform (e.g., a cable, a satellite set-top box, or a digital video recorder), a handheld computer device (e.g., a personal digital assistant (PDA) or an electronic mail client), a wearable terminal (an eyeglasses-type device, a watch-type device, etc.), a virtual reality (VR) terminal, a smart speaker (an audio recognition device), and any other type of computer or communication platform. The terminals 20 may also be referred to as “information processing terminals”.

The terminals 20A, 20B, and 20C may have, for example, the same configuration. A terminal used by a user X may optionally be referred to as a “terminal 20X”, and user information associated with the user X or the terminal 20X in a desired (or alternatively, predetermined) service may optionally be referred to as “user information X”, as desired.

The user information is information on a user associated with an account used by the user in the desired (or alternatively, predetermined) service. User information includes, for example, information that is input by the user or is assigned by the desired (or alternatively, predetermined) service, and that is associated with the user, such as the name, icon image, age, sex, address, hobbies and preferences, and/or identifier of the user. User information may optionally be any one of these types of information or a combination of two or more of these types of information.

The network 30 serves to connect the devices constituting the communication system 1. That is, the network 30 means a communication network that provides a connection path to enable various types of devices mentioned above to transmit and receive data after the devices are connected to each other.

One or more portions of the network 30 may optionally be a wired network or a wireless network. Examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of a public switched telephone network (PSTN), a mobile phone network, an integrated service digital network (ISDN), a radio LAN, long term evolution (LTE), code division multiple access (CDMA), Bluetooth (registered trademark), satellite communication, and a combination of two or more of these networks. The network 30 may include one or more networks 30.

The server 10 (a non-limiting example of a server, an information processing device, or an information management device) functions to provide a desired (or alternatively, predetermined) service (a messaging service and travel plan creation assistance service in this example embodiment) to the terminals 20 and the like. The server 10 may be any information processing device that is capable of realizing the functions described in some example embodiments. Examples of the server 10 include a server device, a computer (e.g., a desktop, a laptop, or a tablet), a media computer platform (e.g., a cable, a satellite set-top box, or a digital video recorder), a handheld computer device (e.g., a PDA or an electronic mail client), and any other type of computer or communication platform. The server 10 may also be referred to as an “information processing device”. If the server 10 and the terminals 20 need not be distinguished from each other, each of the server 10 and the terminals 20 may optionally be referred to as an “information processing device”.

### Hardware (HW) Configurations of Devices

HW configurations of the devices included in the communication system 1 will be described.

### (1) HW Configuration of Terminal

FIG. 1 shows an example of a HW configuration of the terminal 20.

The terminal 20 includes, for example, a controller 21 (central processing unit: CPU), a storage 28, a communication I/F (interface) 22, an input/output device 23, a clock 29A, and a position calculation information detector 29B. The HW constituent elements of the terminal 20 are connected to each other via a bus B, for example. Note that it is not essential to include all of the constituent elements as the HW configuration of the terminal 20. For example, the terminal 20 may optionally be configured such that each one or a plurality of constituent elements are removable.

The communication I/F 22 transmits and receives various data via the network 30. Communication may be performed in a wired or wireless manner, and may be based on any communication protocol that enables mutual communication to be performed. The communication I/F 22 functions to communicate with various devices such as the server 10, via the network 30. The communication I/F 22 transmits various data to various devices, such as the server 10, in accordance with instructions from the controller 21. Also, the communication I/F 22 receives various data transmitted from various devices, such as the server 10, and transfers the data to the controller 21. The communication I/F 22 may also be simply referred to as a “communication device”. The communication I/F 22 may also be referred to as a “communication circuit” in the case where the communication I/F is constituted by a physically structured circuit.

The input/output device 23 includes, for example, a device that inputs various operations made to the terminal 20, and a device that outputs the results of processing performed by the terminal 20. The input/output device 23 may optionally be constituted by a single, integrated input and output device, or separate input and output devices.

The input device is implemented by any one of all types of devices capable of receiving input from a user and transferring information regarding the input to the controller 21, or a combination of two or more of these types of devices. Examples of the input device include a touch panel, a touch display, hardware keys of a keyboard or the like, a pointing device such as a mouse, a camera (operation input via moving images), and a microphone (operation input using voice).

The output device is implemented by any one of all types of devices capable of outputting the result of processing performed by the controller 21, or a combination of two or more of these types of devices. Examples of the output device include a touch panel, a touch display, a speaker (sound output), a lens (e.g., three-dimensional (3D) output or hologram output), and a printer.

As an example, the input/output device 23 includes, for example, a display 24, a sound input device 25, a sound output device 26, and an image capturing device 27.

The display 24 is implemented by any one of all types of devices capable of providing display in accordance with display data written in a frame buffer, or a combination of two or more of these types of devices. Examples of the display 24 include a touch panel, a touch display, a monitor (e.g., a liquid crystal display and an organic electroluminescence display (OELD)), a head mounted display (HDM), and devices capable of displaying images, text information, and the like using projection mapping or holograms, or in the air (may optionally be a vacuum). Note that the display 24 may optionally be capable of displaying display data three-dimensionally.

The sound input device 25 is used to input sound data (which may include audio data; the same applies hereinafter). The sound input device 25 includes a microphone or the like.

The sound output device 26 is used to output sound data. The sound output device 26 includes a speaker or the like.

The image capturing device 27 is used to acquire image data (which may include still image data and moving image data; the same applies hereinafter). The image capturing device 27 includes a camera or the like.

When the input/output device 23 is a touch panel, the input/output device 23 and the display 24 may have substantially the same size and shape and be arranged facing each other.

The clock 29A is a built-in clock of the terminal 20 and outputs time information (time measurement information). The clock 29A includes, for example, a clock that utilizes a crystal oscillator or the like. The clock 29A may also be referred to as, for example, a “time measurement device” or a “time information detector”.

Note that the clock 29A may optionally include a clock to which NITZ (Network Identity and Time Zone) standards or the like are applied.

The position calculation information detector 29B is a functional part that detects (measures) information (hereinafter referred to as “position calculation information”) that is necessary for the controller 21 to calculate (measure) the position of the terminal 20. The position calculation information detector 29B may also be referred to as a “position calculation sensor device”, for example.

Examples of the position calculation information detector 29B include a satellite positioning sensor (a satellite positioning unit) that is a sensor or a unit for calculating the position of the terminal 20 using a satellite positioning system, such as a global positioning system (GPS), an inertial measurement sensor (inertial measurement unit (IMU)) that is a sensor or a unit for calculating the position of the terminal 20 using an inertial navigation system, and a ultra-wide band (UWB) positioning sensor (UWB positioning unit) that is a sensor or a unit for calculating the position of the terminal 20 using a UWB.

The satellite positioning unit has, for example, an radio frequency (RF) receiving circuit that converts, into digital signals, RF signals, which include positioning satellite signals emitted from a positioning satellite and received by an antenna (not shown), and a baseband processing circuit that captures the positioning satellite signals by performing correlation operation processing or the like on the digital signals output from the RF receiving circuit and outputs, as position calculation information, information such as satellite orbit data and time data that are retrieved from the positioning satellite signals.

The inertial measurement unit includes an inertial sensor that detects information necessary to calculate the position of the terminal 20 through an inertial navigation operation. The inertial sensor includes, for example, a three-axis acceleration sensor and a three-axis gyroscope sensor, and outputs, as position calculation information, an acceleration detected by the acceleration sensor and an angular velocity detected by the gyroscope sensor.

The UWB positioning unit has, for example, a ultra-wide band radio frequency (RF) receiving circuit that converts, into digital signals, ultra-wide band RF signals including a positioning ultra-wide band pulse signal emitted from a positioning beacon and received by an antenna (not shown), and a relative position calculation processing circuit that calculates the relative positions of the terminal 20 and the positioning beacon based on the digital signals output from the ultra-wide band RF receiving circuit.

Note that, for example, the UWB positioning unit may optionally cause the terminal 20 to function as a positioning beacon by transmitting ultra-wide band RF signals including a positioning ultra-wide band pulse signal from the antenna (not shown).

For example, the controller 21 calculates the position of the terminal 20 at periodical or specified times, based on the position calculation information detected by the position calculation information detector 29B. The position of the terminal will be referred to as a “terminal position”, and the calculated terminal position will be referred to as a “calculated terminal position”. The controller 21 may optionally store, in the storage 28, the calculated terminal position as calculated terminal position history data in association with the date and time at which the calculated terminal position was calculated.

The controller 21 has a physically structured circuit for executing functions that are implemented by code or commands included in a program, and is implemented by, for example, a data processing device incorporated in hardware. Thus, the controller 21 may optionally be referred to as a “control circuit”.

Examples of the controller 21 include a central processing unit (CPU), a microprocessor, a processor core, a multiprocessor, an application-specific integrated circuit (ASIC), and a field programmable gate array (FPGA).

The storage 28 functions to store various programs and data that are necessary for the terminal 20 to operate. Examples of the storage 28 include various storage media, such as a hard disk drive (HDD), a solid state drive (SSD), a flash memory, a random access memory (RAM), and a read only memory (ROM). The storage 28 may optionally be referred to as a “memory”.

The terminal 20 stores a program P in the storage 28, and the controller 21 executes the program P to perform processing to serve as parts that are included in the controller 21. That is, the program P stored in the storage 28 causes the terminal 20 to implement the functions executed by the controller 21. The program P may optionally be referred to as a “program module”.

### (2) HW Configuration of Server

FIG. 1 shows an example of a HW configuration of the server 10.

The server 10 includes, for example, a controller (CPU) 11, a storage 15, a communication I/F (interface) 14, an input/output device 12, a display 13, and a clock 19. The HW constituent elements of the server 10 are connected to each other via a bus B, for example. Note that it is not essential to include all of the constituent elements as the HW configuration of the server 10. For example, the HW of the server 10 may optionally be configured such that each one or a plurality of constituent elements are removable.

The controller 11 has a physically structured circuit for executing functions that are implemented by code or commands included in a program, and is implemented by, for example, a data processing device incorporated in hardware.

The controller 11 is typically a central processing unit (CPU), and may optionally be a microprocessor, a processor core, a multiprocessor, an ASIC, or an FPGA. In the present disclosure, the controller 11 is not limited to these examples.

The storage 15 functions to store various programs and data that are necessary for the server 10 to operate. The storage 15 is implemented by various storage media, such as an HDD, an SSD, and a flash memory. However, in the present disclosure, the storage 15 is not limited to these examples. The storage 15 may optionally be referred to as a “memory”.

The communication I/F 14 transmits and receives various data via the network 30. Communication may be performed in a wired or wireless manner, and may be based on any communication protocol that enables mutual communication to be performed. The communication I/F 14 functions to communicate with various devices, such as the terminal 20, via the network 30. The communication I/F 14 transmits various data to various devices, such as the terminal 20, in accordance with instructions from the controller 11. Also, the communication I/F 14 receives various data transmitted from the various devices, such as the terminal 20, and transfers the data to the controller 11. The communication I/F 14 may also be referred to simply as a “communication device”. The communication I/F 14 may also be referred to as a “communication circuit” in the case where the communication I/F is constituted by a physically structured circuit.

The input/output device 12 includes, for example, a device that inputs various operations to the server 10, and a device that outputs the results of processing performed by the server 10. The input/output device 12 may optionally be constituted by a single, integrated input and output device, or separate input and output devices.

The input device is implemented by any one of all types of devices capable of receiving input from a user and transferring information regarding the input to the controller 11, or a combination of two or more of these types of devices. The input device is implemented by hardware keys, a typical example of which is a keyboard, and a pointing device such as a mouse. Note that, for example, the input device may optionally include a touch panel, a camera (operation input made via moving images), or a microphone (operation input using voice).

The output device is implemented by any one of all types of devices capable of outputting the result of processing performed by the controller 11, or a combination of two or more of these types of devices. Examples of the output device include a touch panel, a touch display, a speaker (sound output), a lens (e.g., 3D (three-dimensional) output and hologram output), and a printer.

As one example, the input/output device 12 includes, for example, a display 13.

The display 13 is implemented by a display or the like. The display is typically implemented by a monitor (e.g., a liquid crystal display or an organic electroluminescence display (OELD)). Note that the display may optionally be a head mounted display (HDM) or the like. Note that the display may optionally be capable of displaying display data three-dimensionally. In the present disclosure, the display is not limited to these examples.

The clock 19 is a built-in clock of the server 10 and outputs time information (time measurement information). The clock 19 includes, for example, a real time clock (RTC) as a hardware clock, a system clock, or the like. The clock 19 may also be referred to as, for example, a “time measurement device” or a “time information detector”.

### (3) Others

The server 10 stores the program P in the storage 15, and the controller 11 executes the program P to perform processing to serve as parts that are included in the controller 11. That is, the program P stored in the storage 15 causes the server 10 to implement the functions executed by the controller 11. The program P may optionally be referred to as a “program module”. The same applies to the other devices.

Some example embodiments of the present disclosure will be described as being implemented as a result of a CPU of the terminal 20 and/or the server 10 executing the program P. The same applies to the other devices.

Note that the controller 21 of the terminal 20 and/or the controller 11 of the server 10 may optionally implement processing by using not only a CPU including a control circuit, but also a logic circuit (hardware) or a dedicated circuit formed on an integrated circuit (IC) chip or a large scale integration (LSI) chip. Further, these circuits may optionally be implemented by one or more integrated circuits, and a plurality of types of processing described in the embodiments may optionally be implemented by a single integrated circuit. An LSI may also be referred to as a VLSI, a super LSI, an ultra LSI, or the like depending on the chip integration density. Accordingly, the controller 21 may optionally be referred to as a “control circuit”. The same applies to the other devices.

The program P (e.g., a software program, a computer program, or a program module) in the embodiments of the present disclosure may optionally be provided in a state of being stored in a computer-readable storage medium. The program P can be stored in a “non-transitory tangible medium”. Also, the program P may optionally be for implementing some of the functions described in the embodiments of the present disclosure. Furthermore, the program P may optionally be a differential file (differential program) that enables the functions described in the embodiments of the present disclosure to be implemented in combination with the program P that is already recorded in a storage medium.

The storage medium may include one or more semiconductor-based or other integrated circuits (ICs; e.g., field programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards or drives, any other suitable storage media, or a suitable combination of two or more of these storage media. Where appropriate, the storage medium may consist only of a volatile storage medium or a non-volatile storage medium, or a combination of volatile and non-volatile storage media. Note that the storage medium is not limited to these examples, and may be any device or medium that is capable of storing the program P. Further, the storage medium may optionally be referred to as a “memory”.

The server 10 and/or the terminal 20 can implement functions of a plurality of functional parts described in the embodiments by reading the program P stored in the storage medium and executing the read program P. The same applies to the other devices.

The program P according to the present disclosure may optionally be provided to the server 10 and/or the terminals 20 via any transmission medium (a communication network, broadcast waves, etc.) that is capable of transmitting the program. The server 10 and/or the terminals 20 implement(s), for example, the functions of the functional parts described in the embodiments by executing the program P downloaded via the Internet or the like. The same applies to the other devices.

Some example embodiments of the present disclosure may also be implemented in the form of a data signal in which the program P is embodied by electronic transmission.

At least a portion of processing performed in the server 10 and/or the terminal 20 may optionally be implemented through cloud computing constituted by one or more computers.

At least a portion or all of processing to be performed in the terminals 20 may optionally be performed by the server 10. In this case, the server 10 may optionally perform processing to be performed by some or all of the functional parts of the controller 21 of the terminal 20.

At least a portion or all of processing to be performed in the server 10 may optionally be performed by the terminals 20. In this case, the terminal 20 may optionally perform processing to be performed by some or all of the functional parts of the controller 11 of the server 10.

In some example embodiments of the present disclosure, configurations for determination are not essential unless explicitly mentioned otherwise. Desired (or alternatively, predetermined) processing may optionally be activated when a determination condition is satisfied or when a determination condition is not satisfied.

The program according to the present disclosure is implemented using, for example, a script language such as ActionScript or JavaScript (registered trademark), a compiler language such as Objective-C or Java (registered trademark), or a markup language such as HTML Living Standard.

### Functional Configuration of Each Device

### (1) Functional Configuration of Server

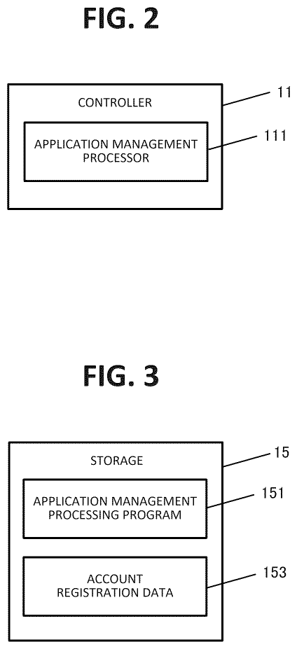

FIG. 2 shows an example of a function implemented by the controller 11 of the server 10 in this example embodiment.

The controller 11 includes, for example, an application management processor 111 as a functional part.

The application management processor 111 functions, for example, to perform application management processing in accordance with an application management processing program 151 stored in the storage 15.

FIG. 3 shows an example of information stored in the storage 15 of the server 10 in this example embodiment.

The storage 15 stores, for example, the application management processing program 151 that is executed as application management processing, and account registration data 153.

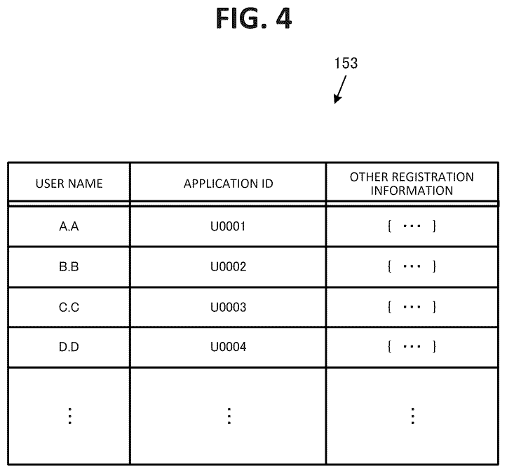

The account registration data 153 is registration data related to accounts on an application (a messaging application in this example embodiment), and an example of a data configuration thereof is shown in FIG. 4. The account registration data 153 includes, for example, a username, an application ID, and/or other registered information, which are stored in association with each other.

The username refers to a name of an account of the terminal 20 that uses this application. For example, a name registered by the user of the terminal 20 when using the application is stored as the username.

The application ID is information that is used to identify an account of the application, or the account itself. The application ID is desirably a value unique to each account. For example, a value (specific value) unique to each account is set and stored as the application ID by the server 10. The application ID is information associated with the terminal 20 or the user of the terminal 20, and is an example of information regarding the terminal or information regarding the user of the terminal.

Other registration information may include, for example, various types of information such as identification information for identifying the terminal 20, a telephone number (terminal telephone number) of the terminal 20, an email address (terminal email address), and authentication information such as a password (login password, authentication password etc.) used in various authentications on the application.

Identification information for identifying the terminal 20 may be, for example, a terminal ID (e.g., an IMEI (International Mobile Equipment Identity)).

For example, other registration information may be stored in association with user information.

Note that the term “application ID” may alternatively be, but need not necessarily be, referred to as the term “user ID”. If the application allows registration of only one account per terminal 20, for example, identification information for identifying the terminal 20 may be equivalent to identification information for identifying the user of the terminal 20, and may also be equivalent to the application ID.

For example, a plurality of terminal IDs may optionally be allocated to one application ID. In this case, the application may optionally be started on a plurality of terminals 20 at the same time for one application ID as an identification (login) target.

Instead of using various IDs such as the application ID, a technique of managing each account using information such as a terminal telephone number can also be applied.

In this case, instead of storing ID information such as the application ID as the account registration data 153, information such as the terminal telephone number can be stored as the account registration data 153. Note that, instead of replacing the ID information such as the application ID with the information such as the terminal telephone number, the ID information such as the application ID may optionally be stored in one-to-one correspondence with the information such as the terminal telephone number.

In the description of the following example embodiments, it is assumed that one account is registered per terminal 20 for simplicity of explanation.

In this case, because the identification information for identifying the terminal 20 is equivalent to the identification information for identifying the user of the terminal 20 and to the application ID as mentioned above, the term “a user of an account” used in the following description may optionally be considered to be substantially synonymous with “a terminal of an account”.

### (2) Functional Configuration of Terminal

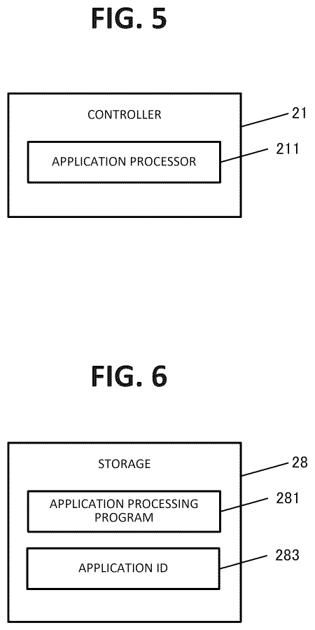

FIG. 5 shows an example of functions implemented by the controller 21 of the terminal 20 in this example embodiment.

For example, the controller 21 includes, as a functional part, an application processor 211 for performing application processing in accordance with an application processing program 281 stored in the storage 28.

FIG. 6 shows an example of data or the like stored in the storage 28 of the terminal 20 in this example embodiment.

The storage 28 stores, for example, the application processing program 281 that is executed as application processing, and an application ID 283 that corresponds to the terminal 20 or the account of the user of the terminal 20.

### Display Screen

The following describes examples of display screens. Transitions of display screens described below are merely examples of transitions of display screens for realizing a method of the present disclosure. Regarding the following examples of transitions of display screens, the display of some display screens may be omitted, or another display screen may be added. Also, the terms used in the display screens described below and the terms used in the processing described later may be different (some terms may not be unified).

The following describes an example in which the terminal 20 is a smartphone having the display 24 that is a vertical display. For example, the smartphone has a touch panel, which functions as an input device and is arranged to face the display to constitute a touchscreen. When an element such as an icon, a button, an item, or an input field is displayed in the display, and the user performs an operation on an area of the touch panel facing the area where the element is displayed, a program associated with the element or a subroutine of the program may be executed.

Note that, in some cases, the flow of a screen transition is illustrated by showing desired (or alternatively, predetermined) screens displayed on different terminals 20 within one drawing or across two or more drawings. In such cases, for example, the different terminals 20 may be configured to display a desired (or alternatively, predetermined) screen based on at least one of the following events (e.g., in response to at least one of the following events as a trigger):
the desired (or alternatively, predetermined) screen is automatically displayed;
a certain notification (including a push notification, etc.; the same applies to the following) is given to the terminal 20, and the desired (or alternatively, predetermined) screen is displayed in response to the user performing an operation on the notification;
no notification is given to the terminal 20, and the desired (or alternatively, predetermined) screen is displayed in response to the user performing a desired (or alternatively, predetermined) operation on the application; or
a certain notification is given to the terminal 20, and the desired (or alternatively, predetermined) screen is displayed in response to the user performing a desired (or alternatively, predetermined) operation on the application to which the notification has been given.

The following illustrates a case in which an account of the terminal 20A of the user A.A is an example of an account that creates a travel plan. In this example, a travel plan is created on the messaging application, and “Messaging App” is represented as an example of the name of the messaging application. Note that the creation of a travel plan may be enabled by an application (e.g., a travel plan creation assistance application) different from the messaging application. In this case as well, a similar screen configuration may be used.

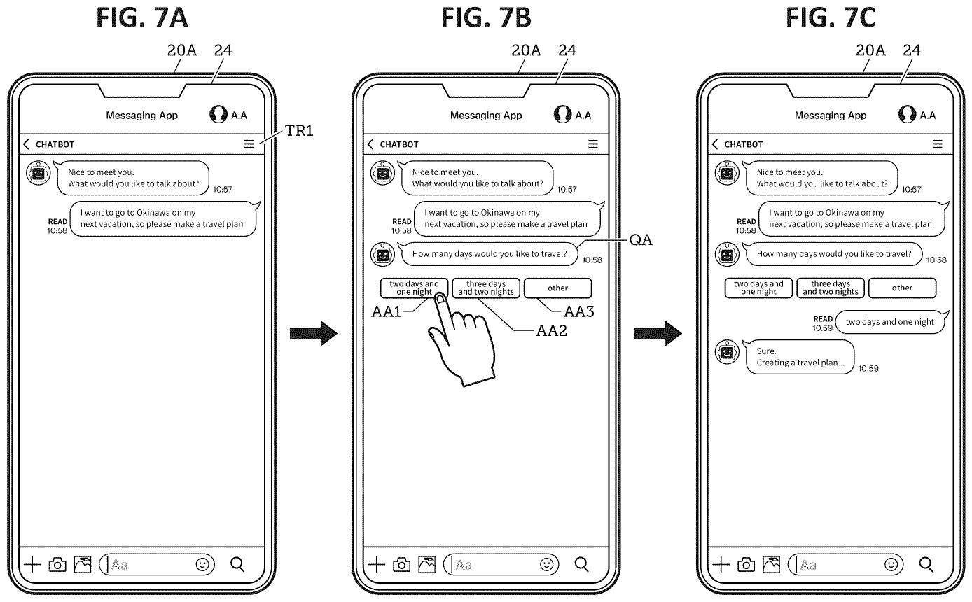

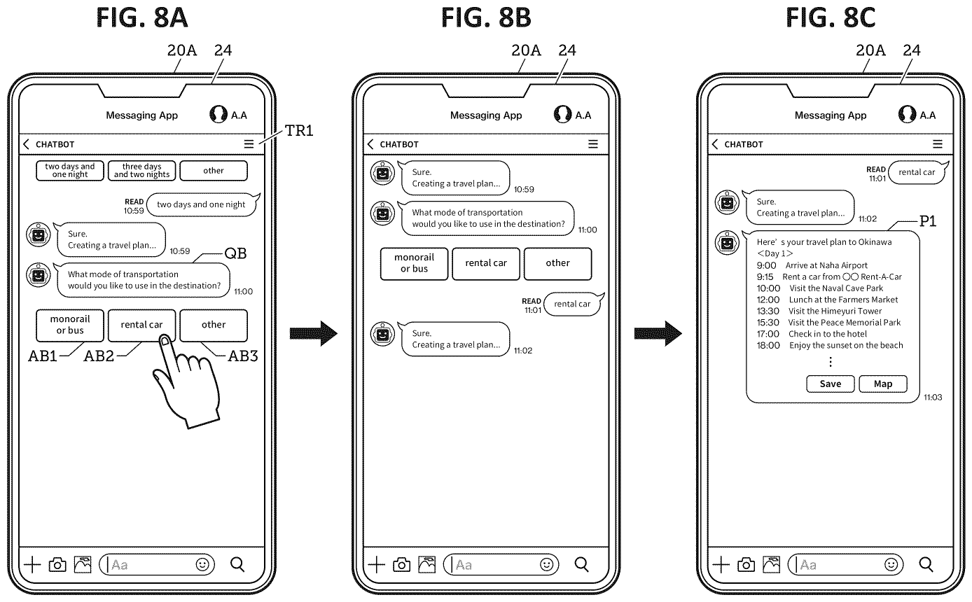

FIGS. 7A, 7B and 7C and FIGS. 8A, 8B and 8C show examples of screens displayed on the display 24 of the terminal 20A in this example embodiment. Note that the term “travel plan”, as used in the drawings, is rephrased as an “itinerary” in the following description, as appropriate.

FIG. 7A shows an example of a talk room screen displayed on the terminal 20A, in which a screen of a one-on-one talk room TR1 with a chatbot as a talk partner (chat partner) is displayed. This screen may be displayed by, for example, tapping a function button for starting the travel plan creation assistance service from a main menu or a selection menu in a talk room on the messaging application.

On the talk room screen, an area in which content and information similar thereto are displayed (hereinafter referred to as a “content display area”) CR is configured. For example, content transmitted by the user themself (e.g., content whose transmission source is the user) may be displayed on the right side of the screen, and content transmitted by the talk partner (e.g., content whose transmission source is the talk partner) may be displayed on the left side of the screen.

The content may be displayed in association with information that enables specification or identification of the transmission source, and may be, for example, displayed in association with the registered icon image of the user. Further, the content may be displayed in a balloon. In this case, the text or the like in the balloon may be regarded as content, or the balloon itself may also be regarded as being included in the content. Also, the content may be displayed without a balloon, depending on the type of content and information included in the content. Different elements (e.g., text, images, and objects such as buttons and icons) may be included in one content item. Such a content item may be referred to as “composite content”, for example.

This screen displays an ongoing conversation about a travel between the user A.A and the chatbot, and shows a scene in which the user A.A is considering traveling to Okinawa. Based on a message “I want to go to Okinawa on my next vacation so make a travel plan” transmitted from the terminal 20A of the user A.A in the talk room TR1, the chatbot (the controller 11 of the server 10) detects information requesting itinerary creation and a travel destination, and creates (generates) a question for efficiently generating an itinerary and response options corresponding to the question.

The chatbot displays, in the talk room TR1, a first question and response options to the first question that are created (generated) based on the information in the talk room TR1 (information transmitted from the terminal 20 to the server 10) (FIG. 7B). In this example, the chatbot (the controller 11 of the server 10) creates a first question QA “How many days would you like to travel?”, creates three response options AA1, AA2, and AA3, namely “two days and one night”, “three days and two nights”, and “other” as the duration of the travel to the travel destination “Okinawa”, and displays objects corresponding to the respective response options in the talk room TR1.

If, for example, the user A.A selects “two days and one night” as the response (FIG. 7C), the chatbot includes the response “two days and one night” in a first prompt sentence, and performs itinerary overview creation processing, which will be described later, to create an itinerary overview. Upon the itinerary creation being started, the chatbot displays a message notifying the user that a travel plan is being created (“Creating a travel plan . . . ”).

After the itinerary overview creation processing ends, the chatbot displays a second question and response options to the second question in the talk room TR1 (FIG. 8A). In this example, the chatbot creates a second question QB “What mode of transportation would you like to use in the destination?”, creates three response options AB1, AB2, and AB3, namely “monorail or bus”, “rental car”, and “other” as transportation modes in the travel destination “Okinawa”, and displays objects corresponding to the respective response options in the talk room TR1.

If, for example, the user A.A selects “rental car” as the response, the chatbot includes the response “rental car” in a second prompt sentence, and performs itinerary element detail search processing, which will be described later, to create an itinerary. Then, a message notifying the user that the travel plan is being created is displayed again (FIG. 8B).

After completing the itinerary element detail search processing, the chatbot displays a created itinerary P1 in the talk room based on the completion of the itinerary creation (FIG. 8C).

### Processing

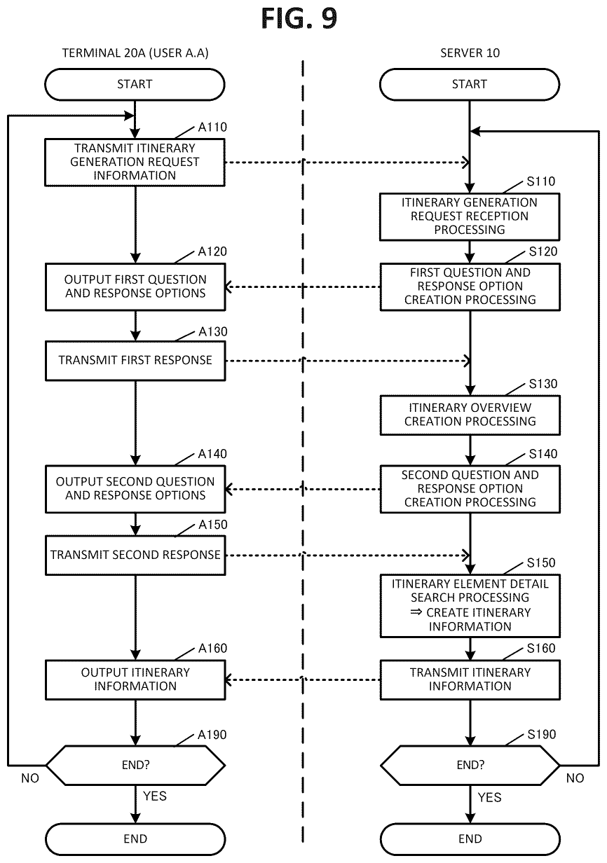

FIG. 9 is a flowchart showing an example flow of processing performed by each device in this example embodiment. In this figure, an example of processing performed by the controller 21 of the terminal 20A of the user A.A is shown in the left diagram of the flowchart, and an example of processing performed by the controller 11 of the server 10 is shown in the right diagram. Note that the processing described below is merely an example of processing for implementing the method of the present disclosure, and the present disclosure is not limited to this processing. Further, another step may be added to the following processing, or some steps may be omitted (deleted) from the following processing.

First, for example, the controller 21 of the terminal 20A transmits itinerary generation request information for generating an itinerary to the server 10 based on input to the input/output device 23 of the terminal 20A (e.g., user input such as operation input or sound input by the user; the same may apply hereinafter) (A110). Note that the itinerary generation request information may be, for example, a character string in a natural language, such as “create a travel plan”. In some example embodiments, the itinerary generation request information may be, for example, a command of an API in the travel plan creation assistance service.

The itinerary generation request information may include, for example, general information regarding the travel destination (place), information regarding the travel duration (days of stay (“two days and one night” etc.)), traveling period (“next weekend”, “from December 23 to December 26” etc.)), and/or information regarding the purpose of travel.

A means for inputting the itinerary generation request information may be, for example, as follows:
message posting to a talk room in the messaging service;
an operation of an itinerary generation button or input to a selection menu (form) from a talk room menu in the messaging service;
text input (interactive instruction) in the travel plan creation assistance application; and
input to a selection menu (form) in the travel plan creation assistance application.

Upon receiving the itinerary generation request information from the terminal 20A, the controller 11 of the server 10 performs itinerary generation request reception processing (S110). In the itinerary generation request reception processing, the controller 11 of the server 10 determines whether an instruction to create an itinerary has been given, using, for example, a question answering model (not shown).

For example, if, in the itinerary generation request reception processing, the itinerary creation request information does not include information regarding a travel destination, dates, or the like, the controller 11 of the server 10 may transmit itinerary check information to the terminal 20A to check the travel destination, dates, or the like. For example, upon receiving the itinerary check information, the controller 21 of the terminal 20A may cause the display 24 to display the received itinerary check information.

The controller 21 of the terminal 20A may also transmit itinerary designation information regarding a travel destination, dates, or the like to the server 10 based on a user input with respect to the itinerary check information.

For example, when information regarding the travel duration is not included, a first question about the travel duration and response options are created and transmitted to the terminal 20A (S120), as described above. That is, the first question and the response options are displayed in the talk room that includes the account of the user A.A and the account of the chatbot (A120). For example, the first question and the response options may be generated by inputting a prompt sentence for generating a question, such as “Please present options for the travel duration for the travel to Okinawa in question form”, based on the travel destination “Okinawa” included in the itinerary generation request information.

Note that the first question and the response options are not limited to those generated by the question answering model, and may alternatively be presented as selection menu items that are prepared in advance, to the terminal 20A.

For example, when the information regarding the travel duration is not included, the controller 11 of the server 10 may select a template question regarding the travel duration “How many days would you like to travel?” from question options prepared in advance and set the selected question as the first question, and may select travel durations (e.g., “two days and one night”, “three days and two nights”), which are frequently input as a travel duration for “Okinawa” recognized as the travel destination and set these travel durations as the response options.

That is, the controller 11 can determine the first question and the response options for obtaining information desired for itinerary overview creation processing from the user, by (i) creating the first question and the response options using a question answering model, or (ii) selecting and setting the first question and the response options from desired (or alternatively, predetermined) options.

Upon the user A.A of the terminal 20A selecting a response (e.g., “two days and one night”) to the first question, a first response indicating the selected response is transmitted from the terminal 20A to the server 10 (A130). The controller 11 of the server 10 performs the itinerary overview creation processing based on the itinerary generation request information and the received first response (S130). In the itinerary overview creation processing, the controller 11 of the server 10 creates itinerary overview information based on the itinerary generation request information and first response selection information, by using, for example, a question answering model (e.g., closed-book question answering system).

In the processing for creating the itinerary overview information, for example, if the controller 11 of the server 10 receives a character string “I want to go to Okinawa, so make a travel plan” as the itinerary generation request information, and a response (character string) “Two days and one night” as the response to the first question “How many days would you like to travel?” as itinerary designation information, for example, the controller 11 may separate the itinerary generation request information and the itinerary designation information with a punctuation mark, and input a first prompt sentence for itinerary creation “I want to go to Okinawa, so make a travel plan. Make it two days and one night.” to a question answering model.

The itinerary overview information may include, for example, the following elements:
a departure location (e.g., a station, an airport, etc. to be an arrival location in an outward trip);
a place to visit (e.g., the name, address, etc. of a facility);
a place to eat;
an accommodation (e.g., the name, address, etc. of a hotel); and
an arrival location (e.g., a station, an airport, etc. to be a departure location in a return trip)

The first prompt sentence may include content indicating that the output includes any of these elements. Further, the first prompt sentence may also incorporate a prompt sentence for requesting that a more detailed schedule and costs be output.

The itinerary overview information may be, for example, a generated sentence that describes rough content of a travel plan. The itinerary overview information may be, for example, a list of a departure point, a place to visit, and/or an accommodation. The itinerary overview information may include, for example, information regarding a rough schedule, estimated costs, or the like.

For example, upon the itinerary overview information being created, the controller 11 of the server 10 creates a second question and response options and transmits them to the terminal 20A, as described above (S140). That is, the second question and the response options are displayed in the talk room that includes the account of the user A.A and the account of the chatbot (A140). For example, the second question and the response options may be generated by inputting a prompt sentence for generating a question “Please present options for the transportation mode in Okinawa in question form”, based on the travel destination “Okinawa” included in the itinerary generation request information.

Note that the second question and the response options are not limited to those generated by the question answering model, and may alternatively be presented as selection menu items that are prepared in advance, to the terminal 20A.

For example, the controller 11 of the server 10 may select a template question “What mode of transportation would you like to use in the destination?” regarding the transportation modes in the travel destination from question options that are prepared in advance and set the selected question as the second question, and may select or provide transportation modes (e.g., “monorail or bus”, “rental car” etc.) that are frequently input as transportation modes in “Okinawa” recognized as the travel destination and set the selected transportation modes as response options.

That is, the controller 11 can determine the second question and the response options for obtaining information desired for itinerary element detail search processing, which will be described later, from the user by (i) creating the second question and the response options using a question answering model, or (ii) selecting the second question and the response options from desired (or alternatively, predetermined) options.

If the user A.A of the terminal 20A selects the response (e.g., “rental car”) to the second question, a second response indicating the selected response is transmitted from the terminal 20A to the server 10 (A150). The controller 11 of the server 10 performs the itinerary element detail search processing based on the itinerary overview information and the received second response (S150).

In the itinerary element detail search processing, the controller 11 of the server 10 creates itinerary information, which is a feasible travel plan, based on the itinerary overview information and the second response (information regarding the transportation mode in the destination) by using, for example, a question answering model (e.g., open-book question answering system) with a travel information database (not shown) as external knowledge (passage).

The travel information database may be able to store various types of information, such as guide information regarding sightseeing spots (e.g., required sightseeing time and fees, URIs of sightseeing facility websites, etc.), information regarding route and required time searches, map information, eating establishment reservation information, accommodation rates and availability information, and/or weather forecasts.

In the itinerary element detail search processing, for example, the controller 11 of the server 10 may input, to the question answering model, a second prompt sentence to make a request to search for feasible routes with the transportation mode designated by the second response and/or accommodation facilities available for stay on the planned dates of stay, using, as a draft, the departure location, place to visit, eating place, and accommodation that are output as the itinerary overview information. Then, itinerary information (including, e.g., the name and address of the eating establishment at the eating place, the name and address of the facility of the accommodation), which corresponds to output sentences of the question answering model, may be generated. The itinerary information may include any element related to the aforementioned itinerary.

The itinerary element detail search processing can eliminate an unfeasible travel plan generated due to hallucination of a language model.

Further, this processing can be implemented by a closed-book question answering system. The itinerary overview information can be generated efficiently by separating the itinerary overview creation processing, which tends to use relatively few resources, from the itinerary element detail search processing. Then, the itinerary element detail search processing is executed based on the generated itinerary overview information, and itinerary information is generated in which the itinerary overview information is refined in line with reality. Thus, a prompt sentence length can be kept relatively short in the itinerary element detail search processing, which tends to use a relatively large amount of access to external resources.

Note that the itinerary element detail search processing is not limited to using a question answering model. For example, the controller 11 of the server 10 may reference the travel information database based on the departure location, the place to visit, and so on in the itinerary overview information, as well as the schedule, and search for a feasible journey by dynamic programming (DP). Then, a retrieved journey may be output as the itinerary information.

Further, the itinerary overview creation processing and the itinerary element detail search processing need not necessarily be explicitly distinguished from each other. For example, the controller 11 of the server 10 may create the itinerary information by referencing the travel information database and performing the same processing as the itinerary overview creation processing.

The controller 11 of the server 10 transmits the itinerary information to the terminal 20A (S160). Upon receiving the itinerary information, the controller 21 of the terminal 20A outputs the received itinerary information (e.g., causes the display 24 to output display) (A160). That is, the control performed by the controller 11 of the server 10 to transmit the itinerary information to the terminal 20A is an example of control for displaying the itinerary information in the talk room in which the user A.A of the terminal 20A participates. After the itinerary information is displayed, for example, the terminal 20 A determines whether to end the processing (A190).

If it is determined that the processing continues (A190: NO), for example, the controller 21 of the terminal 20A returns the processing to A110. On the other hand, if it is determined that the processing ends (A190: YES), the controller 21 of the terminal 20A ends the processing. After the itinerary information is displayed, for example, the server 10 determines whether to end the processing (S190).

If it is determined that the processing continues (S190: NO), for example, the controller 11 of the server 10 waits for receiving itinerary generation request information and returns the processing to S110. On the other hand, if it is determined that the processing ends (S190: YES), the controller 11 of the server 10 ends the processing.

### Effects of First Example Embodiment

According to this example embodiment, the server 10 that communicates with the terminal 20 determines, by the controller 11 of the server 10, questions (a first question and a second question) and response options to the questions (response options to the first question and response options to the second question), based on the itinerary generation request information transmitted from the terminal 20 (S120, S140), and transmits the questions and the response options to the terminal 20 by the controller 11 (A120, A140). Then, the server 10 generates, by the controller 11, an itinerary based on responses (a response to the first question and a response to the second question) selected from the response options by the user of the terminal 20 (S130, S150), and transmits the generated itinerary to the terminal 20 by the controller 11 (S160, A160).

By presenting the user with the information desired to generate an itinerary in a multiple choice format and having the user select an item from the options, it is possible to describe the prompt sentences used to generate the itinerary simply and clearly, reduce the computational load on the server by efficiently generating the itinerary in a relatively short time, and present the user with the generated result, namely the itinerary, without stress.

Here, in the present example embodiment, the first question and the response options for determining an element to be included in a first prompt sentence for generating an itinerary overview are presented, a response (input) to the first question is given, and an itinerary overview is generated based on the first prompt sentence that is based on this response (input). Thereafter, the second question and the response options for determining an element to be included in a second prompt sentence for generating a final itinerary, which is the generated result, are presented. Then, a response (input) to the second question is given, an itinerary overview is generated based on the second prompt sentence that is based on this response (input), and thereafter a final itinerary, which is the generated result, is generated.

That is, the itinerary is generated in a plurality of stages. The questions and response options corresponding to the respective stages are presented to the user, and itinerary generation progresses in accordance with the respective responses. Thus, compared to generating a final result based only on a question and a response in one stage, a final result that further matches the user's preferences can be generated. In addition, the load on the server can be reduced by reducing regeneration (changes) of the entire itinerary.

Further, after the itinerary generation is started based on the response to the first question, the second question and the response options are presented in the process of the generation. This makes it possible to shorten the interval in the communication between the chatbot and the user during the period from the start of the itinerary generation to the presentation of the generated result and reduce or prevent the user from feeling a long waiting time.

Further, in the present example embodiment, the controller 11 of the server 10 executes control to display the generated question and response options as the content provided by the chatbot in the talk room in which the user who requested the itinerary generation participates, and executes control to display the generated itinerary as the content provided by the chatbot in the talk room in which the user who requested the itinerary generation participates.

This configuration provides the user with an interface in which he or she can request the chatbot to generate an itinerary and obtain a final itinerary presented by the chatbot, by answering questions from the chatbot. Such an interface is easy to use for the user.

### Second Example Embodiment

In the first example embodiment, the user A.A requests a chatbot to generate an itinerary in a talk room in which only the user A.A and the chatbot participate. Meanwhile, in the second example embodiment, in a talk room in which a plurality of users and a chatbot participate, the chatbot generates an itinerary based on a request from any of the users.

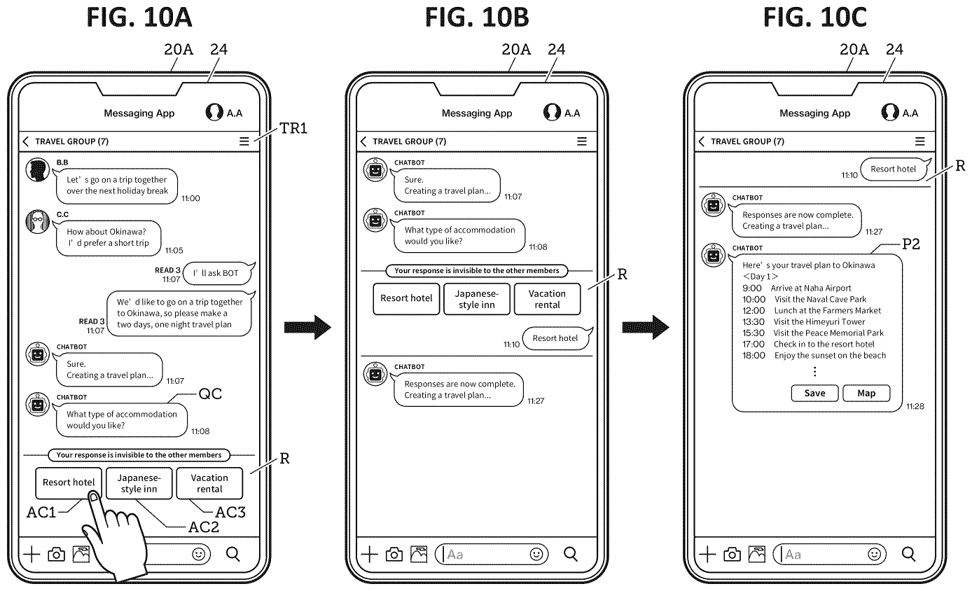

For example, FIG. 10A shows a talk room of a group in which seven users participate, and shows a scene in which a user A.A who read messages from a user B.B and a user C.C requests the chatbot to generate an itinerary.

To obtain an element (text) to be included in a prompt sentence for performing the itinerary element detail search processing, the chatbot generates a question for checking each member's preferences for an accommodation facility, and response options.

Here, one user may not want his or her preference to be known to the other users, such as when many users participate in a talk room. In this example embodiment, a question QC and response options AC1, AC2, and AC3 are displayed in the talk room TR1 on the terminal 20 of each of the users participating in the talk room. However, at least as for the response, the terminal 20 of each user displays only the response of this user, and does not display the responses of the other users.

That is, the controller 11 of the server 10 executes control such that the text of the responses (e.g., A130, A150 in FIG. 9) received from each terminal 20 (the text input as the response of the user of that terminal 20 in the talk room on the terminal 20) is not transmitted to the terminals 20 that are not the transmission source.

Thus, the response of each user is displayed in the talk room on the terminal 20 of this user but is not displayed in the talk room on the terminals 20 of the other users.

In the example shown in FIG. 10A, a notification is given in an area R in the talk room that the response is invisible to the members except for the user A.A. When, for example, the user A.A selects “resort hotel” as his or her response, the response of the user A.A is displayed in the talk room on his or her own terminal 20A, but is not displayed in the talk room on the terminals 20 of the other users, e.g., the terminal 20B of the user B.B.

Based on receiving the responses from a desired (or alternatively, predetermined) number (e.g., all or a majority) of the users participating in the talk room, the chatbot gives a notification in the talk room that the responses have been received, as shown in FIG. 10B, and continues to generate an itinerary.

As shown in FIG. 10C, the chatbot displays a generated itinerary P2 in the talk room. The itinerary P2 is displayed on the terminal 20 of each of the users participating in the talk room, and is shared by the users in the group.

For example, the accommodation facility to be adopted for the itinerary is determined by majority vote. If the number of users who answered “resort hotel” is the largest, “resort hotel” is adopted. Accordingly, the itinerary reflects the responses from some of the users (e.g., their response is included in the itinerary displayed on their own terminal 20), but does not reflect the responses from the other users (e.g., their response is not included in the itinerary displayed on their own terminal 20). In this example, the response from the user A.A who has responded the survey is reflected in the itinerary.

Note that the response to be reflected in the itinerary may be determined based on the attributes of the users who are the respondents (e.g., a user who is representative of the group, a user for whom discretion is set, a user who has a higher expense ratio than the other users, a user whose birth month includes the dates of the travel, etc.).

### Effects of Second Example Embodiment

In the second example embodiment, the server 10 determines, by the controller 11 thereof, a question and response options to the question based on itinerary generation request information transmitted from the terminal 20 of one user in a talk room in which a plurality of users and a chatbot participate (S120, S140), and transmits the question and the response options to the terminals 20 by the controller 11 (A120, A140).

When planning a travel within a group to which a plurality of users belong, the itinerary can be shared within the group by generating the itinerary using the chatbot.

When, for example, the user A.A answers on his or her own terminal 20A, his or her response is displayed in the talk room on his or her own terminal 20A, but is not displayed in the talk room on the terminal 20B of the user B.B who participates in the same talk room. Meanwhile, when the user B.B answers on their own terminal 20B, his or her response is displayed in the talk room on his or her own terminal 20B, but is not displayed in the talk room on the terminal 20A of the user A.A who participates in the same talk room.

This reduces or prevents each user's preferences from being known to the other users who participate in the same talk room, allowing the users to reflect his or her preferences in the itinerary without excessively considering the other users.

Further, the terminal 20 of each user does not display the responses of the other users in the talk room, thereby making it possible to shorten the region from the itinerary generation request to the presentation of the generated result. This makes it possible to avoid complication caused by successive display of the responses of many users in the talk room, and allows the users to easily understand from the talk room how the itinerary has been generated.

### Third Example Embodiment

In the third example embodiment, a chatbot generates an itinerary in a talk room in which a plurality of users and the chatbot participate, based on a request from any of the users.

In the second example embodiment, each user inputs a response in a first talk room (an example of a first chat room) in which information giving an instruction to generate an itinerary (e.g., “Make an itinerary”) is input and the itinerary is shared. However, there is no limitation to such control. As will be described in the third example embodiment, the talk room in which each user inputs a response may be a second talk room (an example of a second chat room that is different from the first chat room) that is different from the first talk room.

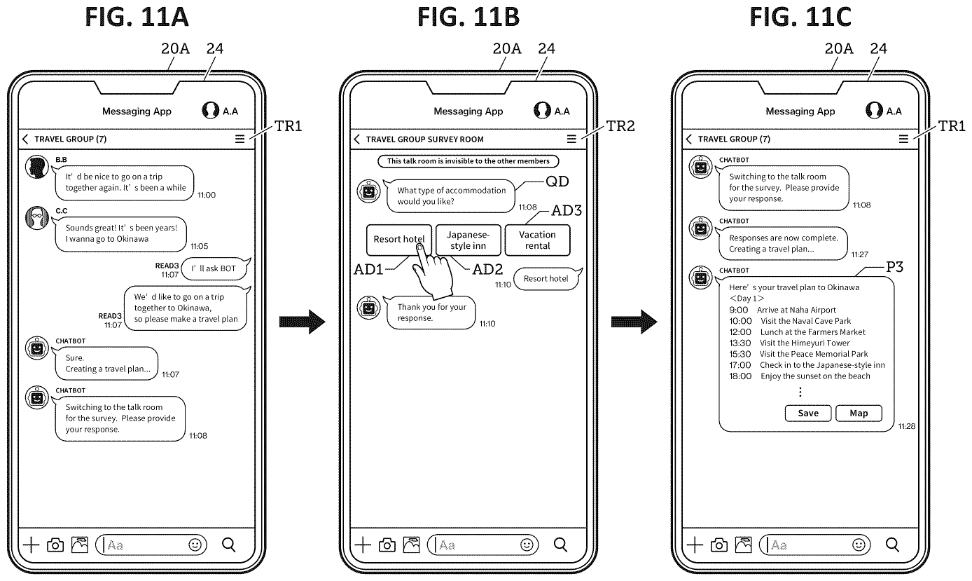

In the example shown in FIG. 11A, in a first talk room TR1 that is displayed on the terminal 20A of the user A.A and in which a plurality of users (seven in this example embodiment) participate, a chatbot gives a notification that an itinerary is being created, and thereafter gives a notification that the talk room will switch to a second talk room TR2 for a survey, where the users will respond to the survey.

In the example shown in FIG. 11i, the talk room displayed on the terminal 20A is switched from the first talk room (travel group (7)) to the second talk room (travel group survey room). In the second talk room TR2, a notification is given that this talk room is invisible to the other users (users other than A.A).

For example, based on an instruction to create a travel plan, the controller 11 of the server 10 generates (sets), for each of the users participating in the first talk room TR1, the second talk room TR2 that includes only the user and the chatbot, and transmits the second talk room TR2 to the terminal 20 of the user (e.g., executes control to cause the display 24 to display the second talk room TR2).

For example, for the user A.A, a second talk room TR2 in which only the user A.A and the chatbot participate and in which the other users in the first talk room TR1 do not participate is generated (set) and displayed on the display 24 of the terminal 20A of the user A.A.

In the second talk room TR2, the chatbot asks the user A.A regarding a preferred or desired accommodation facility and presents response options. That is, a question QD and response options AD1, AD2, and AD3 generated by the controller 11 of the server 10 are transmitted to the terminal 20A of the user A.A and displayed in the second talk room TR2.

Upon the user A.A selecting their preferred or desired accommodation facility (e.g., “resort hotel”) in the second talk room TR2, the selected response is displayed as a message from the user A.A in the second talk room TR2. Based on the user A.A completing the response, the chatbot gives a notification that the response has been received and that the talk room will switch to the previous first talk room TR1.

For example, based on the user completing the response, the controller 11 of the server 10 instructs the terminal 20 of the user who has completed the response to switch to the first talk room TR1 (or retransmits the first talk room TR1 thereto), and executes control to display the first talk room TR1 again on the terminal 20 of this user.

In the example shown in FIG. 11C, the talk room displayed on the terminal 20A has been switched from the second talk room (travel group survey room) to the first talk room (travel group (7)).

In the example shown in FIG. 11C, continuing from FIG. 11A, the chatbot gives a notification in the first talk room TR1 that the responses have been received, based on the responses having been received from a desired (or alternatively, predetermined) number (e.g., all or a majority) of the users participating in the talk room, and continues to generate an itinerary.

As shown in FIG. 11C, the chatbot displays a generated itinerary P3 in the first talk room TR1. The itinerary P3 is displayed on the terminal 20 of each of the users participating in the talk room, and is shared by the users in the group. Here, as mentioned above, the itinerary may or may not reflect the response from each user.

In this example, the response from the user A.A who has responded to the survey (preferred or desired accommodation facility: resort hotel) is not reflected in the itinerary (accommodation facility: Japanese-style inn).

### Effects of Third Example Embodiment

In the third example embodiment, a question and response options generated by the controller 11 of the server 10 are transmitted not to the first talk room of the group in which an itinerary generation request was made, but to the second talk room in which only one user participating in the group and the chatbot participate. This reduces or prevents each user's preferences from being known to the other users who participate in the same talk room, allowing the users to reflect their preferences in the itinerary without excessively considering the other users.

Further, a question to the user, response options, and a response are not displayed in the first talk room of the group, but are displayed in the second talk room in which only the user and the chatbot participate. This makes it possible to shorten the region in the first talk room from the itinerary generation request to the presentation of the generated result. This makes it possible to avoid complication caused by the question, the response options, and the response being displayed in the first talk room, and allows the user to easily understand in the first talk room how the itinerary has been generated.

### Fourth Example Embodiment

For example, a question and/or response options may be generated based on user information about the user.

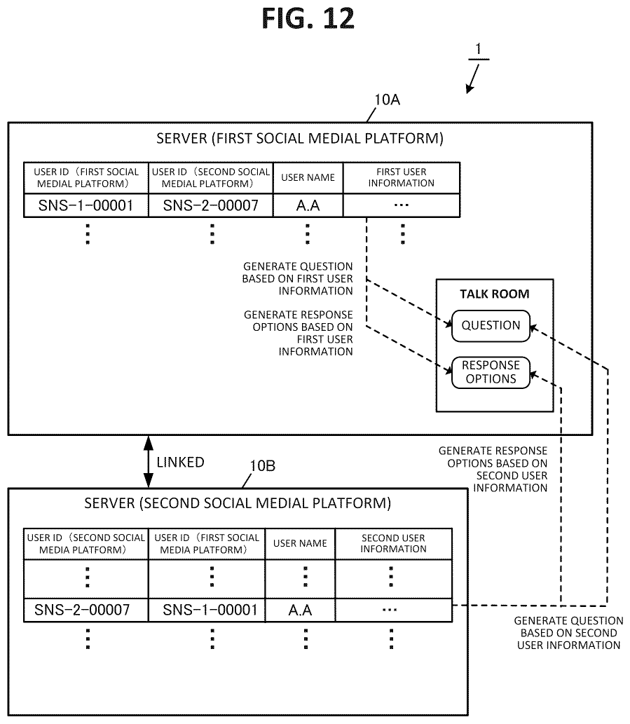

FIG. 12 is a function diagram showing a process in which the controller 11 of a server 10A that executes control related to a talk room (e.g., controls information to be displayed in the talk room based on information transmitted from the terminal 20 of the user) generates a question and/or response options to be displayed in the talk room based on the user information.

In this example, a first service is a first social media platform that enables users who have accounts (SNS-1-∘∘∘∘∘) of the first service to communicate therebetween using a talk room.

The controller 11 of the server 10A that provides the first social media platform can generate a question and/or response options based on first user information in the first social media platform stored in the storage 15 of the server 10A, and display the generated response options in the talk room.

That is, the user A.A has an account (SNS-1-00001) of the first social media platform, and first user information about the user A.A is stored. Based on this, a question to the user A.A and/or response options can be presented based on the first user information about the user A.A.

### 1. Response Option Generation Based on User Information

For example, a configuration may be used in which, if “driver's license: not licensed” is registered as user information about the user A.A, a response option “rental car” as a transportation mode is not displayed in the talk room on the terminal 20A, and a response option “taxi” is alternatively displayed in the talk room on the terminal 20A.

That is, the controller 11 of the server 10A may generate, as response options, transportation modes different from those for the other users (users for whom “driver's license: licensed” is registered) based on the user information about the user A.A registered in the first social media platform, and transmit the generated response options to the terminal 20A.

Here, the user A.A may not want the other users to see the response options that are based on the user information about the user A.A and the response selected from these response options.

In this case, a configuration may be used in which the response options and the response based on the user information are displayed in the talk room TR1 only on the terminal 20A of the user A.A that is associated with that user information, and are not displayed in the talk room TR1 on the terminals 20 of the other users (refer to the second example embodiment).

That is, when the controller 11 of the server 10A generates response options based on the itinerary generation request information displayed in the talk room TR1 and information that is different from information displayed in the talk room TR1 and is user information (e.g., “driver's license: not licensed”) regarding the user A.A, the generated response options and the response are displayed in the talk room TR1 on the terminal 20A of the user A.A, but are not displayed in the talk room TR1 on the terminal 20B of the user B.B in the same group.

When the controller 11 of the server 10A generates response options based on the itinerary generation request information displayed in the talk room TR1 and information that is different from information displayed in the talk room TR1 and is user information (e.g., “driver's license: licensed”) regarding the user B.B, the generated response options and the response are displayed in the talk room TR1 on the terminal 20B of the user B.B, but are not displayed in the talk room TR1 on the terminal 20A of the user A.A in the same group.

Also, the user A.A may not want the other users to see not only the response options based on the user information about the user A.A and the response selected from the response options, but also the corresponding question.

In this case, a configuration may be used in which the response options based on the user information, the response, and the corresponding question are displayed only in a second talk room TR2 in which only the user A.A and the chatbot participate, and are not displayed in a first talk room TR1 in which the user A.A and the other users participate, on the terminal 20A of the user A.A that is associated with that user information (refer to the third example embodiment).

That is, when the controller 11 of the server 10A generates response options based on the itinerary generation request information displayed in the talk room TR1 and information that is different from information displayed in the talk room TR1 and is user information regarding the user A.A, the response options, the response, and the corresponding question are restricted from being displayed in the talk room TR1 on the terminal 20B of the user B.B, and are displayed in the second talk room TR2 that is different from the first talk room TR1 and in which the user A.A participates but the user B.B does not participate, on the terminal 20A of the user A.A.

When the controller 11 of the server 10A generates response options based on the itinerary generation request information displayed in the talk room TR1 and information that is different from information displayed in the talk room TR1 and is user information regarding the user B.B, the response options, the response, and the corresponding question are restricted from being displayed in the talk room TR1 on the terminal 20A of the user A.A, and are displayed in the second talk room TR2 in which the user B.B participates but the user A.A does not participate, on the terminal 20B of the user B.B.

### 2. Question Generation Based on User Information

For example, a configuration may be used in which, when a schedule of the user A.A is registered as user information about the user A.A, a question “The dates in the itinerary to be generated from now overlap with your work schedule. Does that work for you?” and response options “Yes” and “No” are displayed in the talk room on the terminal 20A.

That is, the controller 11 of the server 10A may generate a question for checking the dates in the itinerary to be generated, based on the user information about the user A.A registered in the first social media platform, generate corresponding response options, and transmit the generated question and response options to the terminal 20A.

Here, the user A.A may not want the other users to seethe question and response options based on the user information about the user A.A, and the response selected from the response options.

In this case, a configuration may be used in which the question and response options based on the user information, and the response selected from the response options are displayed in a talk room TR1 only on the terminal 20A of the user A.A that is associated with that user information, and are not displayed in the talk room TR1 on the terminals 20 of the other users (refer to the second example embodiment).

In this case, a configuration may be used in which the question and response options based on the user information, and the response are displayed only in a second talk room TR2 in which only the user A.A and the chatbot participate, and are not displayed in a first talk room TR1 in which the user A.A and the other users participate, on the terminal 20A of the user A.A that is associated with that user information (refer to the third example embodiment).

### Linkage Between First Service and Second Service

A server 10B shown in FIG. 12 provides a second service, which is a second social media platform that enables users having accounts (SNS-2-xxxxx) of the second service to communicate therebetween in a form (e.g., image posting or live streaming) that is different from the talk room on the first social media platform.

The first service of the server 10A and the second service of the server 10B may be linked to share user information. For example, the server 10A stores an account of the user A.A on the first social media platform (SNS-1-00001) and an account of the user A.A on the second social media platform (SNS-2-00007) in association with each other. The server 10B stores the account of the user A.A on the second social media platform (SNS-2-00007) and the account of the user A.A on the first social media platform (SNS-1-00001) in association with each other.

This enables the server 10A to specify the account of the user A.A on the second social media platform that is associated with the account thereof on the first social media platform, obtain user information about the user A.A associated with the account on the second social media platform from the server 10B, and generate a question and/or response options based on the obtained user information.

This enables the controller 11 of the server 10A to generate a question and/or response options based on not only user information in the first social media platform but also user information in the second social media platform.

### Fifth Example Embodiment

In the examples of the above embodiments, a question and response options are presented to the user before itinerary creation, and an itinerary is generated (determined) based on the response of the user. However, a configuration may also be used in which the controller 11 of the server 10 generates (determines) a question and/or response options after itinerary generation in order to reserve a service or a facility included in an itinerary after the itinerary is generated, and displays the generated question and/or response options in a talk room on the terminal 20 of the user.

For example, to check with the user (to obtain from the user) information desired for reserving a service such as an optional tour or a guide, or a facility such as an eating establishment or an accommodation facility included in the generated itinerary, the controller 11 may generate a question and response options based on the generated itinerary and user information and transmit the generated question and response options to the terminal 20. The controller 11 of the server 10 may perform processing for reserving the service or the facility based on a response in response to the user who has checked the question and the response options displayed in the talk room on the terminal 20 selecting a response from the response options.

In the following example, the server 10 that provides the talk room is linked with a reservation management server (not shown) that performs processing for reserving a service or a facility and manages reservation information. The controller 11 of the server 10 causes the reservation management server to reserve a service or a facility included in a generated itinerary.

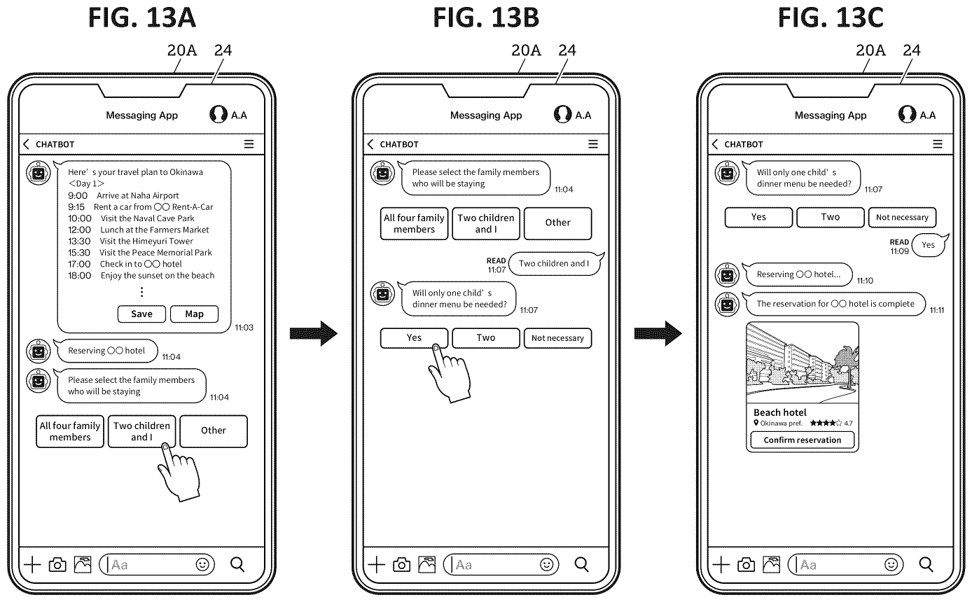

FIGS. 13A, 13B and 13C show an example of a screen displayed on the terminal 20A of the user A.A according to the fifth example embodiment. Here, the generated itinerary is displayed in the talk room (11:03).

As shown in FIG. 13A, to reserve a facility (oo hotel in this example) included in the itinerary after generating the itinerary, the controller 11 of the server 10 generates a question and response options based on (i) information regarding the itinerary (accommodation facility) and (ii) user information (family structure) about the user A.A, and transmits the generated question and response options to the terminal 20A. In this example, the user information managed in association with identification information about the user A.A includes the family structure (e.g., a family of four including a spouse and two children) of the user A.A. Based on this, the controller 11 generates a question for checking the family member who will stay at ∘∘ hotel (“Select family members who will stay at the hotel”) and response options (“all four family members”, “two children and I”, and “other”) to the question, and transmits the generated question and response options to the terminal 20A (displayed in the talk room at 11:04).

When the user A.A selects “two children and I” (11:07), based on the user information managed in association with the identification information about the user A.A including the ages of the two children of the user A.A (e.g., one child is a junior high school student and the other one is an elementary school student), the controller 11 of the server 10 generates a question for checking if only one child's dinner menu is needed (for the elementary school student) (“Will only one child's dinner menu be needed?”), as well as response options (“Yes”, “Two”, and “Not necessary”) to the question, and transmits the question and response options to the terminal 20A (displayed in the talk room at 11:07), as shown in FIG. 13B.

When the user A.A selects “Yes” (11:09), as shown in FIG. 13C, based on the obtained information desired for reserving ∘∘ hotel (the dates of stay based on the itinerary, the plan that the user A.A and their 2 children will stay, and the preference that one child's dinner menu is needed), the controller 11 of the server 10 transmits, to the reservation management server, reservation request information that includes identification information about the user A.A, the dates of stay based on the generated itinerary, and the guests (the user A.A and their two children), and the selection of dinner (two adult's menus and one child's dinner menu) to reserve ∘∘ hotel. Further, the controller 11 notifies the user A.A that processing for reserving ∘∘ hotel is in progress (displayed in the talk room at 11:10).

Based on the reservation request information, the reservation management server stores the identification information about the user A.A, the number of persons to stay (three), and dinner selection information (two adult's menus and one child's dinner menu), in association with one room capable of accommodating three or more persons at ∘∘hotel, thereby completing the reservation processing. Then, reservation completion information is transmitted to the server 10. The server 10 transmits, to the terminal 20A, a message that the reservation for ∘∘ hotel has been completed, based on the reservation completion information (displayed in the talk room at 11:11), and also transmits image information for confirming the reservation for ∘∘ hotel (displayed in the talk room at 11:11). Upon the user A.A tapping a “confirm reservation” button on the image information, the controller 21 of the terminal 20A obtains reservation information (the dates of stay, the number of persons to stay, and the selection of dinner) associated with the identification information about the user A.A from the reservation management server via the server 10, and displays the obtained reservation information on the display 24 (talk room). The user A.A can confirm the reservation status in the talk room. Here, a configuration may also be used in which, when the user taps the “confirm reservation” button, the application may switch from the messaging application to another application, rather than the reservation status being displayed in the talk room, and the screen may transition to a reservation status confirmation web page on a hotel reservation service linked with the message service via account integration, or a reservation status confirmation page in a hotel reservation service application.

By thus generating a question and response options based on the generated itinerary and user information, a reservation can be made while reflecting the circumstances of the individual user based on the generated itinerary. In addition, reservations for services or facilities included in the itinerary can be completed all at once through the talk room in which the itinerary is displayed, thereby improving user convenience.

In this example, the controller 11 of the server 10 generates a question and response options for checking family members who will stay with the user A.A of the terminal 20A to perform processing for reserving an accommodation facility included in the itinerary. Here, for example, when performing processing for reserving a rental car, the controller 11 may generate a question and response options for having the user select a driver, based on user information regarding whether the user has a driver's license. For example, based on two family members (e.g., the user A.A and the spouse) out of the accompanying family members having driver's licenses, the controller 11 of the server 10 may generate a question “Will you (user A.A) drive by yourself?” and three response options “Yes”, “My spouse will drive”, and “My spouse and I will take turns driving”, and transmit the generated question and response options to the terminal 20A of the user A.A (e.g., displayed in the talk room).

In this manner, a question or response options corresponding to a service or a facility included in the itinerary may be generated. That is, a question or response options may also be changed in accordance with a change in the itinerary (a service or a facility to be reserved), and user information used to generate the question or response options may also be changed. For example, after an itinerary is generated and presented to the terminal 20 once, the controller 11 of the server 10 may regenerate an itinerary and transmit the regenerated itinerary to the terminal 20 (e.g., display the regenerated itinerary in the talk room) in response to the user of the terminal 20 making an input for changing the itinerary (e.g., an input of a message “Change the accommodation place” or “Change the transportation mode”) in the talk room in which the itinerary is displayed.

Furthermore, a question or response options may also be regenerated in accordance with the re-generation of the itinerary. Here, as user information used to generate the question or response options, user information different from the user information used to generate the previous question or response options may be used.

### First Variation (1)

FIG. 13 shows an example of a talk room in which only the user A.A and a chatbot participate. However, as described in the second or third example embodiment, a question or response options may be generated based on user information about each user in a talk room in which other users (e.g., the user B.B) also participate, after an itinerary is shared between the users.

For example, a configuration may be used in which, when response options are generated based on user information about the user A.A, these response options and the response are displayed in the talk room on the terminal 20A of the user A.A, but are not displayed in the talk room on the terminal 20B of the user B.B. Meanwhile, when response options are generated based on user information about the user B.B, these response options and the response are displayed in the talk room on the terminal 20B of the user B.B, but are not displayed in the talk room on the terminal 20A of the user A.A (refer to the second example embodiment).

For example, a configuration may be used in which, when response options are generated based on user information about the user A.A, the corresponding question, the response options, and the response are displayed in the talk room on the terminal 20A of the user A.A, but are not displayed in the talk room on the terminal 20B of the user B.B. Meanwhile, when response options are generated based on user information about the user B.B, the corresponding question, the response options, and the response are displayed in the talk room on the terminal 20B of the user B.B, but are not displayed in the talk room on the terminal 20A of the user A.A (refer to the second example embodiment).

For example, a configuration may be used in which, when a question is generated based on user information about the user A.A, this question, response options, and the response are displayed in the talk room on the terminal 20A of the user A.A, but are not displayed in the talk room on the terminal 20B of the user B.B. Meanwhile, when a question is generated based on user information about the user B.B, this question, response options, and the response are displayed in the talk room on the terminal 20B of the user B.B, but are not displayed in the talk room on the terminal 20A of the user A.A (refer to the second example embodiment).

For example, a configuration may be used in which, when a question or response options are generated based on user information about the user A.A, the question, response options, and the response are not displayed in the talk room but are displayed in a different talk room, which is a first talk room in which the user A.A and a chatbot participate (and the user B.B does not participate) on the terminal 20A of the user A.A. Meanwhile, when a question or response options are generated based on user information about the user B.B, the question, response options, and the response are not displayed in the talk room but are displayed in a different talk room, which is a second talk room in which the user B.B and a chatbot participate (and the user A.A does not participate) on the terminal 20B of the user B.B (refer to the third example embodiment).

Note that, when, of a question and response options, only response options are generated based on user information about the user A.A, the corresponding question may be displayed in not only the first talk room but also the talk room. Meanwhile, when, of a question and response options, only response options are generated based on user information about the user B.B, the corresponding question may be displayed in not only the second talk room but also the talk room.

### First Variation (2)

In the fifth example embodiment, the user information used to generate a question or response options is not limited to the information managed by the server 10A that provides the talk room as described in the fourth example embodiment, but may alternatively be information managed by the server 10B that provides a different social media platform. That is, the user information used to generate a question or response options may be information managed by the server 10A (first social media platform) that controls information to be displayed in the talk room, or information obtained from the server 10B of the second social medial platform that is linked with the first social medial platform.

A question or response options may also be generated based on information managed on an account for another service linked with an account of a user (the user A.A in the example in FIG. 13) managed by the server 10A. Examples of other services may include, but are not limited to, travel reservation services that handle reservations for all aspects of travel, including hotels and transportations on behalf of users, services that handle reservations and ticket management for sightseeing and events, schedule management services (including calendar apps that allow multiple people to share schedules), and services that handle reservation and ticket management for transportation such as airline tickets and train tickets.

Regarding information integration with those other services, questions or response options may be generated using information about a user only if the user gives permission to share information in advance. The prior permission may also be obtained in the form of a question from a chatbot in a conversation. For example, after an itinerary is generated, a question “You have linked your account to ●● travel service. May I use your information managed for this service to generate questions and response options to complete the reservation?” may be transmitted, a question or response options may be generated based on the user information only if the user responds that they permit it.

Note that the user information used to generate a question or response options may be information that the user previously transmitted as a message to the talk room (e.g., “Our family of four went out to eat”), and this user information may be included in the information managed by the server 10A that provides the talk room. For example, a question or response options for the user may be generated by learning the information previously transmitted as a message in the talk room by the user. As to whether to execute learning, the learning may be enabled only if the user gives permission in advance.

In the above-described second, third and fifth example embodiments, each user may be enabled to set whether to display at least one of a question, response options, or a response in a talk room in which a plurality of users (the user A.A, the user B.B) and a chat bot participate on the terminal of the user. Only when the user configures a setting not to display it, the display control described in the second or third example embodiment may be executed on the corresponding terminal 20 to restrict information displayed in the talk room. Note that the information displayed in the talk room may be restricted by a setting configured by a specific user (e.g., a group administrator) among the plurality of users. Also, the information displayed in the talk room may be restricted based on an agreement between a desired (or alternatively, predetermined) number (e.g., a majority or all) of the plurality of users.

### Other Example Embodiments

The terminal 20 may perform at least part of the processing that is performed by the server 10 in the above-described example embodiments. Conversely, the server 10 may perform at least part of the processing that is performed by the terminal 20 in the above example embodiments.

The operator of the server 10 may also be an image generation service provider that partners with the messaging service provider. In this case, the processing described in the example embodiments and variations may be implemented by a single server or distributed in a server system constituted by a plurality of servers.

Note that, for example, a system constituted by one or more servers may be defined as a server system, and thus the server of the present disclosure may be referred to as a server system. For example, the server system may be constituted by an information processing device, an image generating device, and/or a language generating device.

In the above example embodiments and variations, the server for distributing various applications (the server from which the terminal 20 downloads the applications) may be a server that is different from the server or the like that provides corresponding services (applications). That is, a server for delivering the applications and a server or the like that performs application management processing or the like described in the above example embodiments and variations may be configured as physically separated servers or as a single server.

The applications are not limited to including programs for various applications, but may also include, for example, programs that provide the functionality of another service as one function of a primary application (e.g., a program that provides the functionality of an advertisement distribution service as one function of the messaging application, or vice versa), and programs for updating the primary application. The programs may also include data utilized in the application programs (including data for updating the applications, etc.).

Furthermore, in the above example embodiments and variations, for example, a method for implementing some example embodiments of the present disclosure using a client-server system has been described, but example embodiments of the present disclosure are not limited to this. As mentioned above, some example embodiment may also be implemented by a system such as a distributed system in which the terminal 20 has the functions of a server or server system. For example, the terminal may perform the processing that is described as being performed by the server or the server system according to the flowcharts described in the above example embodiments.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

As described above, the content described in the above example embodiments, variations, and other example embodiments may be applied in combination with each other.

What is claimed is:

1. A non-transitory computer readable medium storing a program to be executed by a server that communicates with at least one terminal, the program configured to cause the server to:
generate, by a controller of the server, an itinerary based on information transmitted from the terminal;
transmit, by the controller, the generated itinerary to the terminal;
determine, by the controller, at least one of a question regarding the itinerary or at least one response option to the question, based on (i) information regarding the itinerary and (ii) user information about a user of the terminal; and
transmit, by the controller, at least one of the question or the response option to the terminal.

2. The non-transitory computer readable medium storing the program according to claim 1, wherein the program further configured to cause the server to:
perform, by the controller, processing for reserving a service or a facility included in the itinerary, based on a response selected from the at least one response option by the user of the terminal.

3. The non-transitory computer readable medium storing the program according to claim 2, wherein
the information transmitted from the terminal includes information that has been displayed in a chat room in which the user participates,
the transmitting of the generated itinerary to the terminal includes executing control to display the itinerary in the chat room, and
the transmitting of the at least one of the question or the response option to the terminal includes executing control to display the at least one of the question or the response option in the chat room.

4. The non-transitory computer readable medium storing the program according to claim 3, wherein
the at least one terminal includes a first terminal of a first user and a second terminal of a second user, and
the information transmitted from the terminal includes information displayed in the chat room in which the first user and the second user participate.

5. The non-transitory computer readable medium storing the program according to claim 4, wherein the program further configured to cause the server to
control the first terminal and the second terminal such that the response option and the response are displayed in the chat room on the first terminal and are restricted from being displayed in the chat room on the second terminal, in response to the controller determining the response option based on the information regarding the itinerary and user information about the first user, and
control the first terminal and the second terminal such that the response option and the response are displayed in the chat room on the second terminal and are restricted from being displayed in the chat room on the first terminal, in response to the controller determining the response option based on the information regarding the itinerary and user information about the second user.

6. The non-transitory computer readable medium storing the program according to claim 4, wherein the program further configured to cause the server to
control the first terminal and the second terminal so that the question, the response option, and the response are displayed in the chat room on the first terminal and are restricted from being displayed in the chat room on the second terminal, in response to the controller determining the question based on the information regarding the itinerary and user information about the first user, and
control the first terminal and the second terminal such that the question, the response option, and the response are displayed in the chat room on the second terminal and are restricted from being displayed in the chat room on the first terminal, in response to the controller determining the question based on the information regarding the itinerary and user information about the second user.

7. The non-transitory computer readable medium storing the program according to claim 4, wherein the program further configured to cause the server to
control the first terminal such that the question, the response option, and the response are restricted from being displayed in the chat room on the first terminal and are displayed in a first chat room on the first terminal, the first chat room on the first terminal being different from the chat room on the first terminal and in which the first user participates and the second user does not participate, in response to the controller determining the question or the response option based on the information regarding the itinerary and user information about the first user, and
control the second terminal such that the question, the response option, and the response are restricted from being displayed in the chat room on the second terminal, and are displayed in a second chat room on the second terminal, the second chat room on the second terminal being different from the chat room on the second terminal and in which the second user participates and the first user does not participate, in response to the controller determining the question or the response option based on the information regarding the itinerary and user information about the second user.

8. The non-transitory computer readable medium storing the program according to claim 3, wherein the user information is information associated with the user in a first service configured to provide the chat room or a second service linked with the first service.

9. An information processing method to be performed by a server that communicates with a terminal, the method comprising:
generating, by a controller of the server, an itinerary based on information transmitted from the terminal;
transmitting, by the controller, the generated itinerary to the terminal;
determining, by the controller, at least one of a question regarding the itinerary or at least one response option to the question, based on (i) information regarding the itinerary and (ii) user information about a user of the terminal; and
transmitting, by the controller, at least one of the question or the response option to the terminal.

10. A server that communicates with a terminal, comprising:
a controller configured to
generate an itinerary based on information transmitted from the terminal,
transmit the generated itinerary to the terminal,
determine at least one of a question regarding the itinerary or at least one response option to the question, based on (i) information regarding the itinerary and (ii) user information about a user of the terminal, and
transmit the at least one of the question or the response option to the terminal.
